(19) United States
(12) Patent Application Publication
(10) Pub. No.: US 2018/0145400 A1
(43) Pub. Date: May 24, 2018

(54) ANTENNA

(71) Applicant: Kathrein-Werke KG, Rosenheim (DE)

(72) Inventors: Roland GABRIEL, Griesstaett (DE); Andreas VOLLMER, Rosenheim (DE)

(21) Appl. No.: 15/569,729

(22) PCT Filed: Apr. 27, 2016
(86) PCT No.: PCT/EP2016/000684

§ 371 Date: Oct. 26, 2017

(30) Foreign Application Priority Data
Apr. 29, 2015 (DE) 10 2015 005 468.6

(51) Int. Cl. H01Q 1/24; H01Q 21/24; H01Q 9/04; H01Q 19/20

(52) U.S. Cl. CPC H01Q 1/246; H01Q 19/20; H01Q 9/0485; H01Q 21/245

(57) ABSTRACT

An antenna for a mobile telecommunication base station has a plurality of radiating elements and at least two transmission paths or at least two receiving paths, which have different polarizations and are linked with two of the radiating elements and physically distanced from each other. The radiating elements are dielectric radiating elements. The individual radiating element interval between the radiating elements is less than 0.6λ, wherein λ is the wavelength of the center frequency of the lowest resonance frequency range of the radiating elements.

The present invention relates to an antenna, in particular an antenna for a mobile telecommunication base station with a plurality of radiating elements.

Antennas for base stations usually have a broad-band design in order to transmit and receive as many frequency bands and as many received and transmitted signals as possible with one antenna and one antenna connector.

Document DE 10 2013 012 305 A1 discloses an antenna array with broad-band radiating elements, wherein at least one additional radiating element, which emits in a higher frequency band than the broadband radiating elements, is provided between two columns of broadband radiating elements.

However, the broad-band capacity of the radiating elements leads to large antennas and filters.

Thus the use of different radiating elements arranged in two adjacent vertical planes for different frequency bands is known from U.S. Pat. No. 6,211,841 B1. The intention is to thereby make better use of the available space, without the individual radiating elements influencing each other. A base station antenna is also known from US 2010/0227647 A1, in which two blocks of radiating elements are arranged alternatingly in a vertical row. The radiation patterns of the two blocks of antennas thus have different vertical orientations. Symmetrical, dual-polarized individual radiating elements are employed in both documents. Moreover, a multi-column multi-band antenna array with a first and a second group of radiating elements for transmitting and receiving in a first and a second frequency band is known from DE 10 2007 060 083 A1. Patent US 2014/0368395 A1 discloses the use of two antenna arrays for different frequency bands, arranged in a common housing.

Additionally, a base station antenna is known from U.S. Pat. No. 7,808,443 B2, in which narrow-band antennas that are assigned to adjacent frequency bands are arranged alternatingly in a vertical row. The radiating elements can be radiating elements with a dielectric resonator. The radiating elements within the vertical row of radiating elements can be separated by an interval of between 0.3 and 0.7λ. Moreover, it is disclosed that the transmission and reception paths can be linked with different radiating elements. In this way, the antennas can be linked to the transmission and receiving amplifiers via filters with low selectivity and low edge steepness. A radiating element with a dielectric resonator that covers two frequency bands is known from H. Raggad et al., “A Compact Dual Band Dielectric Resonator Antenna For Wireless Applications”, International Journal of Computer Networks & Communications (IJCNC) Vol. 5, No. 3, May 2013, published on 6 Jun. 2013.

The use of dielectric individual radiating elements and the use of interleaving methods to utilize the volume of an antenna more efficiently are thus already known. Additionally, the beam-forming yield during MIMO transmission methods in antennas with interleaving is lower than in antennas without interleaving. However, symmetrical, dual-polarized individual radiating elements are used for this purpose in the prior art.

Asymmetrical radiating elements are known from mobile terminals, for example. In that case, though, radiating elements with high bandwidth and little decoupling from each other are employed. Furthermore, the antennas of terminals are subject to different requirements from antennas of base stations.

According to a further but not previously published application by the applicant with application number GB 1413256.7, the use of separate antennas for the transmission and receiving paths is also known, as is the use of two separate, physically distant antennas for the different polarizations in one frequency band. A fifth antenna is thus arranged between four such antennas, and large system intervals are formed among the individual antennas as a result. Dipolar antennas or patch antennas are used as antennas in this instance.

The problem addressed by the present invention is that of providing a compact antenna, in particular for use in mobile telecommunication base stations, which has a simple design to support various transmission technologies and/or contributes to separating transmission and receiving paths.

According to the invention, this problem is solved by antennas disclosed in claims 1, 2 and 4.

Advantageous embodiments of the antennas according to the invention are the subject matter of the sub-claims.

According to a first aspect, the present invention relates to an antenna, in particular an antenna for a mobile telecommunication base station, with a plurality of radiating elements and at least two transmission paths and/or at least two receiving paths. If two transmission paths are provided, they are linked with two radiating elements, which are physically distant from each other and have different polarizations. If two receiving paths are provided, they are linked with two radiating elements, which are physically distant from each other and have different polarizations.

According to a first aspect, the radiating elements are dielectric radiating elements. The use of a dielectric permits the size of the antennas to be reduced. A dielectric radiating element according to the present invention preferably includes a dielectric resonator. In particular, the dielectric radiating element can be a dielectric resonator antenna (DRA). By using a resonator material with a high dielectric constant, it is possible to design antennas of this type to be very small. Moreover, dielectric resonator antennas have a high quality factor and low bandwidth. Furthermore, dielectric resonator antennas have high multi-mode and/or multi-band capacity and, owing to their low aperture, have asymmetric far fields, which contribute to decoupling between the radiating elements.

Additionally, according to the first aspect, the individual radiating element interval between the radiating elements is less than 0.6λ, wherein λ stands for the wavelength of the center frequency of the lowest resonance frequency range of the radiating elements. This system interval between the individual radiating elements of the antenna exists both in the vertical and in the horizontal directions. A very compact antenna arrangement is achieved as a result of the small individual radiating element interval between the radiating elements. Furthermore, advantages are achieved from the decoupling and beam-forming applications. The resonance frequency range of each radiating element is preferably defined as a continuous range with return loss of better than 6 dB and preferably better than 10 dB.

According to the invention, dielectric radiating elements with an individual radiating element interval of less than 0.6λ from each other are used.

Thus, in a first embodiment, an antenna according to the invention can have at least two transmission paths and at least two receiving paths, which are linked to the radiating elements separately from each other. In a second embodiment, an antenna according to the invention can have only transmission paths or only receiving paths, and so there is likewise a separation between the transmission and receiving paths.

The separation of the transmission and receiving paths according to the invention as well as the physically distanced antennas with different polarizations permit a high level of MIMO functionality in the antenna and also allow for usage with different transmission method and lower intermodulation between Rx and Tx. Moreover, separating the transmission and receiving paths makes it possible to forgo highly selective filters for Rx-Tx separation, i.e. to separate the transmit and receive signals.

The radiating elements used according to the first aspect can be radiating elements with only one connector and/or only one polarization. Also according to the first aspect, however, radiating elements with at least two separate connectors for at least two different polarizations can be used. The first aspect additionally indicates that radiating elements with at least two separate connectors for at least two different polarizations can be used, though.

In a second aspect, the present application relates to an antenna, in particular an antenna for a mobile telecommunication base station, having at least two radiating elements, which are physically distanced from each other and have different polarizations and/or are operated at different frequencies, wherein the radiating elements are dielectric radiating elements with at least two separate connectors for at least two different polarizations.

The use of radiating elements of this type permits the antenna to have an even more compact design.

Preferable here is an individual radiating element interval of less than 0.6λ between the radiating elements, wherein λ stands for the wavelength of the center frequency of the lowest resonance frequency range of the radiating elements. The advantages represented above with regard to the first aspect are achieved in this way.

Preferred embodiments according to the first and the second aspect are discussed in greater detail below:

An individual radiating element interval of less than 0.2λ between the radiating elements is preferred, wherein λ stands for the wavelength of the center frequency of the lowest resonance frequency range of the radiating elements. If the individual radiating element interval between the radiating elements is selected to be even less, then it is not possible to achieve sufficient decoupling between the individual radiating elements. Furthermore, even smaller intervals create disadvantages with regard to the possibility of beam-forming applications.

Where a beam-forming or beam-steering application is concerned, the optimal individual radiating element interval between the radiating elements is less than or equal to 0.25λ, since a group interval of less than or equal to 0.5λ then results for the interval between two similar radiating elements within a larger arrangement, and especially effective beam-forming or beam-steering is possible as a result of this group interval. Nevertheless, the interval between the radiating elements also cannot be selected arbitrarily small, since otherwise it is often not possible to achieve sufficient decoupling between the radiating elements.

Therefore, the individual radiating element interval of the radiating elements for the center frequency of the lowest resonance frequency range of the radiating elements is preferably less than or equal to 0.30λ, more preferably less than or equal to 0.28λ, most preferably less than or equal to 0.25λ.

Therefore, the individual radiating element interval of the radiating elements for the center frequency of the lowest resonance frequency range of the radiating elements is preferably between 0.2λ and 0.3λ, more preferably between 0.2λ and 0.28λ, most preferably between 0.2λ and 0.25λ.

In this way, the radiating elements for the transmission paths and the reception paths can have different resonance frequency ranges, and/or the individual radiating elements can have multiple separate resonance frequency ranges, which are used for various mobile telecommunication frequency bands. The individual radiating element interval of the radiating elements for the center frequencies of all of the resonance frequency ranges used for the radiating elements is preferably between 0.2λ and 0.6λ.

Moreover, the individual radiating element interval between the radiating elements for the center frequency of the highest resonance frequency range of the radiating elements is preferably between 0.4λ and 0.6λ.

According to a third aspect, the present invention further comprises an antenna, in particular an antenna for a mobile telecommunication base station, with at least two repeating base cells consisting of a plurality of radiating elements. Each base cell comprises a plurality of radiating elements and at least two transmission paths and/or at least two receiving paths, where in the at least two transmission paths of each base cell are linked with two radiating elements, which are physically distanced from each other and have different polarizations, and/or wherein the at least two receiving paths of each base cell are linked with two radiating elements, which are physically distanced from each other and have different polarizations. According to a first aspect, the radiating elements are dielectric radiating elements.

According to a fourth aspect, the present application further comprises an antenna, in particular an antenna for a mobile telecommunication base station, having at least two repeating base cells consisting of a plurality of radiating elements, wherein each base cell comprises at least two radiating elements, which are physically distanced from each other and have different polarizations and/or are operated at different frequencies, wherein the radiating elements are dielectric radiating elements with at least two separate connectors for at least two different polarizations.

Preferred aspects of this type of antenna consisting of multiple base cells according to the third and the fourth aspect are described below:

The base cells preferably have a similar design, i.e. they have radiating elements with the same polarizations and/or with the same resonance frequency ranges and/or the radiating elements can be operated with the same frequency bands, wherein the radiating elements within the base cells preferably have the same arrangement, wherein the base cells more preferably have an identical design. In particular, the base cells can each have similar and preferably identical transmission and/or receiving paths and radiating elements, and/or the radiating elements in each base cells can be arranged the same way.

The antenna consisting of multiple base cells, as claimed in the invention, permits the use both of beam-forming applications in which the radiating elements of the individual base cells are operated together and of applications in which the radiating elements of each base cell are operated separately and/or individually.

Thus an antenna according to the invention can, in a first embodiment, consist of base cells that have at least two transmission paths and at least two receiving paths, which are linked to the radiating elements separately from each other. In a second embodiment, an antenna according to the invention can consist of a plurality of base cells, which have only transmission paths, each preferably having four transmission paths, or of a plurality of base cells, which have only receiving paths, each preferably having four receiving paths, so that separate antennas are provided for the transmission and receiving paths.

Preferably, the base cells repeat with a group interval of between 0.4λ and 1.2λ. Here the letter λ stands for the wavelength of the center frequency of the lowest resonance frequency range of the radiating elements. The interval is preferably less than 1.0λ.

Furthermore, the group interval for the center frequency of the lowest resonance frequency range of the radiating elements is preferably less than or equal to 0.60λ, more preferably less than or equal to 0.56λ, most preferably less than or equal to 0.50λ.

The group interval for the center frequency of the lowest resonance frequency range of the radiating elements is preferably between 0.4λ and 0.6λ, more preferably between 0.40λ and 0.56λ, most preferably between 0.40λ and 0.50λ.

The group interval for the center frequencies of all of the resonance frequency ranges used for the radiating elements is preferably between 0.4λ and 1.2λ. Furthermore, the group interval for the center frequencies of the highest resonance frequency ranges used for the radiating elements can lie between 0.8λ and 1.2λ.

Furthermore, the interval between two base cells is preferably double the interval of the radiating elements within a base cell.

According to a preferred embodiment, the radiating elements of the base cells can be operated separately and/or individually in a first operating mode. The plurality of base cells thus makes available a correspondingly high number of transmission channels.

Moreover, the radiating elements of the individual base cells can be interconnected into one or more groups in a second operating mode. In particular, similar radiating elements of the base cells, i.e. radiating elements that have the same polarization and the same resonance frequency range(s) and/or that can be operated in the same frequency bands and/or that have the same arrangement, can be interconnected for transmitting and receiving, wherein the similar radiating elements are preferably constructed or arranged identically. In particular, this permits the radiating elements of the transmission paths of multiple base cells that all have the same polarization to be interconnected into a transmission antenna array. Similarly, the radiating elements of the receiving paths of multiple base cells that all have the same polarization to be interconnected into a receiving antenna array. Beam-forming applications are possible in this way. The signals that are made available to the individual radiating elements within a group can be out of phase with each other in order to influence the orientation of the radiation pattern in the vertical or horizontal direction and can possibly be driven at different amplitudes. They are interconnected preferably by interconnecting the transmitting and receiving paths.

According to the invention, a plurality of base cells can be arranged one above the other in the vertical direction. Alternatively or additionally, a plurality of base cells can be lined up next to each other in the horizontal direction. Vertical beam-forming is thus possible as a result of the vertical arrangement of the base cells. Horizontal beam-forming is possible as a result of the horizontal arrangement of the base cells. Asymmetries in the radiation pattern of the individual radiating elements, which arise as a result of the spatial separation of the polarizations, can be balanced out by the multiple base cells and the interconnection of individual radiating elements into groups.

The antenna according to the third and fourth aspect of the present invention is preferably configured according to the first and/or second aspect of the present invention. In particular, the individual base cells of an antenna according to the third and fourth aspect is preferably configured according to the first and/or second aspect of the present invention. However, the individual aspects of the present invention can also be applied independently of each other.

Preferred embodiments of an antenna according to one or more aspects of the present invention are presented in greater detail below. With regard to the fourth aspect, any mention of transmission and receiving paths refers to the transmission and/or receiving paths within a base cell unless otherwise indicated. With regard to the third and/or fourth aspect, any mention of radiating elements refers likewise refers to the radiating elements within a base cell unless otherwise indicated:

A separation between the transmission paths and the receiving paths is preferably established, i.e. each of the radiating elements is linked either with one or more transmission paths or with one or more receiving paths, but not with both a receiving path and a transmission path.

An antenna and/or a base cell according to the invention can, in a first embodiment, have at least two transmission paths and at least two receiving paths, which are linked to the radiating elements separately from each other. In particular, an antenna and/or base cell can have at least two transmission paths and at least two receiving paths, each of which is linked with two physically distanced radiating elements of different polarizations.

In a second embodiment, an antenna and/or base cell according to the invention can have only transmission paths or only receiving paths, and so there is likewise a separation between the transmission and receiving paths.

Moreover, an antenna and/or base cell according to the invention can have at least four transmission paths and at least four receiving paths, each of which is linked with four physically distanced radiating elements of different polarizations.

Furthermore, the antenna and/or base cell can have at least two transmission paths and two receiving paths, each of which is linked with two physically distanced radiating elements that each have at least two connectors. In this instance, the two transmission paths are preferably linked with two connectors of a first radiating element, and the two receiving paths are preferably linked with two connectors of a second radiating element. The polarization of the two radiating elements can be the same or different.

Preferably, the radiating elements form a two-dimensional antenna arrangement and, in particular, are arranged with a predetermined vertical and/or horizontal individual radiating element interval from each other. In particular, the radiating elements can be arranged in horizontal rows and/or vertical columns and, in particular, are arranged with a predetermined vertical and/or horizontal individual radiating element interval from each other. In particular, the radiating elements can be arranged in horizontal rows and/or vertical columns, each with at least two radiating elements.

The two radiating elements that are linked with the transmission paths preferably have polarizations that are orthogonal or rotated 45° to each other.

Alternatively or additionally, the two radiating elements that are linked with the receiving paths can have polarizations that are orthogonal or rotated 45° to each other. The two radiating elements are arranged here such that they are physically separated from each other.

Improved decoupling and/or MINO functionality and/or different connection options are made available as a result. In a first embodiment, the two radiating elements can have opposite polarizations that are arranged at 45° to the vertical. In a second embodiment, the first radiating element can be polarized horizontally and the second radiating element vertically. The radiating elements preferably have only one polarization.

If dual-polarized radiating elements are used, the first radiating element can be polarized vertically and horizontally, and the second radiating element can have two opposite polarizations that are arranged at 45° to the vertical.

Furthermore, according to the second embodiment, the four radiating elements, with which the at least four transmission paths are linked, each have polarizations that are rotated 90° or 45° relative to each other, or the four radiating elements, with which the at least four receiving paths are linked, each have polarizations that are rotated 90° or 45° relative to each other.

The isolation between the transmission and receiving paths achieved in the antenna according to the invention is preferably at least 10 dB. The isolation more preferably reaches at least 15 dB. This isolation is preferably achieved both when they are activated separately and when the radiating elements are interconnected.

In a preferred embodiment, the at least two transmission paths and/or the at least two receiving paths are each linked with two similar and preferably identical radiating elements, which are rotated relative to each other at a prescribed angle. In particular, the two or four similar and preferably identical radiating elements are rotated by 45° or by 90° and are spatially offset from each other. Similar radiating elements preferably have the same resonance frequency ranges and/or can be operated in the same frequency bands. Identical radiating elements are preferably constructed identically and, also preferably, have dielectric bodies with identical dimensions and/or identical feed lines.

This permits a simple and cost-effective design and prevents unintentional differences between the transmission paths or between the receiving paths.

The design consisting of at least two similar and preferably identical radiating elements, which are arranged such that they are rotated relative to each other, and/or the spacing between the radiating elements guarantees high conformality and especially orthogonality in the far field and/or good decoupling between two identical radiating elements, in particular in multi-band radiating elements, since the angular position of the fields emitted by the radiating elements are not influenced by directional deviations in the polarization of individual field modes of the radiating elements.

The radiating elements are preferably arranged such that they are rotated by a particular angle to each other relative to an axis, which is perpendicular to the base of the antenna and/or perpendicular to the plane spanned by the polarization vectors of the radiating elements.

In a preferred embodiment of the present invention, at least two or four transmission paths of the antenna or base cell according to the invention, depending on the embodiment, serve to transmit signals in the same frequency range and/or mobile telecommunication band. Alternatively or additionally, the at least two or four transmission paths can be linked with two radiating elements that have the same resonance frequency range. According to the invention, two or four radiating elements of different polarizations, which are physically distant from each other, are thereby employed to transmit in one frequency band or mobile telecommunication band.

In a preferred embodiment, the at least two or four transmission paths and/or the at least two or four receiving paths are each linked with two similar and preferably identical radiating elements, which are rotated relative to each other at a prescribed angle. In particular, the two or four similar and preferably identical radiating elements are rotated by 45° or by 90° and are spatially offset from each other.

If four transmission paths are provided, then they are preferably linked with four similar and preferably identical radiating elements, which are rotated by an angle of 0°, 90°, 180° and 270°. The radiating elements that are rotated 180° to each other can be operated either together or separately. The radiating elements, which are rotated 180° to each other, are thus preferably arranged on the diagonals of the base cell.

It is further preferred that at least two or at least four receiving paths of an antenna or base cell, depending on the embodiment, serve to receive signals in the same frequency range and/or mobile telecommunication band. Alternatively or additionally, the at least two or four receiving paths can be linked with two or four radiating elements that have the same resonance frequency range. Furthermore, the at least two or four receiving paths are also linked with two or four similar and preferably identical radiating elements, which are rotated relative to each other at a prescribed angle. In particular, the two or four radiating elements, which are linked with the two or four receiving paths, are configured similarly and preferably identically and are rotated by 45° or by 90° and are spatially offset from each other.

If four receiving paths are provided, then they are preferably linked with four similar and preferably identical radiating elements, which are rotated by an angle of 0°, 90°, 180° and 270°. The radiating elements that are rotated 180° to each other can be operated either together or separately. The radiating elements, which are rotated 180° to each other, are thus preferably arranged on the diagonals of the base cell.

If the antenna or base cell has two transmission paths and two receiving paths, then the two radiating elements that are linked with the transmission paths and the two radiating elements that are linked with the receiving paths are each preferably arranged in a row or column, but not diagonally to each other. In this way, the electronics for the transmission paths and the receiving paths can be more effectively separated within the antenna.

Furthermore, the base cell and/or antenna can have at least two transmission paths, which are linked with two connectors of a radiating element having different polarizations. The two transmission paths can preferably serve to transmit signals in the same frequency range and/or mobile telecommunication band, and/or the two connectors of the radiating element can have the same resonance frequency range and different polarizations.

Furthermore, the base cell and/or antenna can have at least two receiving paths, which are linked with two connectors of a radiating element having different polarizations. The two receiving paths can preferably serve to receive signals in the same frequency range and/or mobile telecommunication band, and/or the two connectors of the radiating element can have the same resonance frequency range and different polarizations.

Regardless of the concrete design of the antenna, the radiating elements that are linked with the transmission paths and the radiating elements that are linked with the receiving paths are preferably constructed differently and/or have different transmission and reception properties. According to the invention, the individual antennas can be optimally adjusted to their task of transmitting or receiving signals.

The radiating elements that are linked with the transmission paths and the radiating elements that are linked with the receiving paths thereby preferably have different resonance frequency ranges. Preferably, each of the resonance frequency ranges corresponds to a transmission range or a receiving range of a mobile telecommunication band. In particular, the antenna can be used for transmitting or receiving in at least one mobile telecommunication band, wherein the antennas assigned to the transmission and receiving paths are each configured to transmit and receive in the different frequency bands used within a mobile telecommunication bank such as this.

It is also preferred that the radiating elements, which in particular are operated at different frequencies according to the second and the fourth aspects, are constructed different and/or have different resonance frequency ranges. Preferably, each of the resonance frequency ranges corresponds to a transmission range or a receiving range of a mobile telecommunication band, wherein the resonance frequency ranges of the radiating elements preferably do not cover both a transmission range and a receiving range of a mobile telecommunication band.

In this regard, regardless of the concrete design, at least one of the radiating elements and preferably all of the radiating elements are preferably configured for narrow-band signals. The narrow-band configuration of the radiating elements permits the use of filters with low selectivity and low edge steepness and thus small dimensions and low costs.

Preferably, each resonance frequency range of the radiating elements covers either only a transmission frequency range or only a receiving frequency range of a mobile telecommunication band. In particular, it is preferable that the resonance frequency ranges of the radiating elements do not cover both a transmission range and a receiving range of a mobile telecommunication band.

According to the invention, however, at least one of the radiating elements and preferably all of the radiating elements can have multiple separate resonance frequency ranges. An individual radiating element can thus be employed for transmitting or for receiving in multiple resonance frequency ranges and can therefore be used in a plurality of mobile telecommunication bands. For example, a first resonance frequency range can cover a first mobile telecommunication band and/or a first transmission or receiving range of a first mobile telecommunication band, and a second resonance frequency range can cover a second mobile telecommunication band and/or a transmission or receiving range of a second mobile telecommunication band. There is preferably a large interval between the two resonance frequency ranges in this case. This can be achieved in particular by the use of a harmonic of a fundamental frequency for the second resonance frequency range. If dielectric radiating elements are used as according to the invention, then the resonance frequency ranges can be predetermined by the dimensions of the dielectric resonator.

According to one possible embodiment, the radiating elements can also have three or more separate resonance frequency ranges or can cover three or more different mobile telecommunication bands separately from each other. The radiating elements preferably have exactly two or three or more separate resonance frequency ranges or cover exactly two or three or more different mobile telecommunication bands separately from each other.

In one possible embodiment of the present invention, the at least two receiving paths and the at least two transmission paths according to the first embodiment, or the at least four receiving paths or the at least four transmission paths according to the second embodiment, can each be linked with one of four physically distant radiating elements separately from each other. According to the invention, both the radiating elements that are used for transmission and receiving and the different polarizations for the transmission and receipt are thereby physically distanced from each other. In particular, the four radiating elements can for a two-dimensional antenna arrangement, as indicated above, and can be arranged in particular in two rows and two columns.

Moreover, the antenna or base cell according to the invention can have at least four physically distant radiating elements in a first and preferred embodiment. The base cell preferably has exactly four radiating elements. They preferably form a two-dimensional antenna arrangement, i.e. the positions of the radiating elements span a two-dimensional plane. This plane preferably has a vertical orientation.

A base cell preferably contains at least four and more preferably exactly four radiating elements. In particular, two similar and preferably identical, physically distanced radiating elements, which are rotated by 45° or 90° relative to each other, can be used for the transmission paths. Likewise, two similar and preferably identical, physically distanced radiating elements, which are rotated by 45° or 90° relative to each other, can be used for the receiving paths. Die radiating elements for the transmission paths and the receiving paths preferably have difference resonance frequency ranges. Alternatively, four similar and preferably identical, physically distanced radiating elements, which are rotated by 90° relative to each other, can be used for the four transmission and receiving paths.

However, a base cell can also have at least two and more preferably exactly two or four radiating elements, each of which has at least two separate connectors for different polarizations.

If the base cell has two radiating elements, then the first radiating element is preferably linked with two transmission paths and the second radiating element with two receiving paths, and the polarizations of the radiating elements are oriented the same way, or the two radiating elements are linked with two transmission paths each or two receiving paths each, and the polarizations of the radiating elements are oriented differently and in particular are rotated by 45°.

A base cell with four radiating elements can consist of two such base cells with two radiating elements, wherein the arrangement of the radiating elements within the two combined base cells is preferably inverted and/or mirrored. The orientation of the radiating element polarizations within the base cell can be the same for all of the radiating elements, or it can be different for all of the radiating elements, or it can be partially different and partially the same.

The radiating elements can be arranged at a prescribed vertical and horizontal distance from each other. The spacing between the radiating elements in the vertical and horizontal direction is preferably the aforementioned interval, i.e. in particular between 0.2λ and 0.6λ. The radiating elements can preferably be arranged in horizontal rows and/or vertical columns, each with at least two radiating elements. In particular, the antenna can have at least two rows and at least two columns of radiating elements.

As was described above, at least one radiating element can have two separate inputs. In this way, the functionality of four antennas with only one input can be provided by two antennas having two separate inputs. Moreover, all radiating elements of the antennas or base cells described above can have this design.

Preferably, the two separate inputs of an antenna such as this correspond to two different polarizations of the radiating element. However, the field distributions and/or modes addressed by the two inputs preferably have the same resonance frequency range. In particular, it can be provided that the radiating element is linked to a first transmission path by a first connector and to a second transmission path by a second connector, wherein the two transmission paths preferably serve to transmit in the same frequency band. It can further be provided that the radiating element is linked to a first receiving path by a first connector and to a second receiving path by a second connector, wherein the two receiving paths preferably serve to receive in the same frequency band. Preferably, the receiving paths and the transmission paths are each linked with separate radiating elements.

If dielectric radiating elements are employed, then the two inputs are provided by different striplines, with which the same dielectric resonator is excited in different polarizations.

In this way, in one possible embodiment, at least four transmission paths of the antenna or base station according to the invention can be linked with the connectors of two physically distanced radiating elements, which have the same or different polarizations and preferably are rotated by 45° to each other, and/or at least four receiving paths with the connectors of two physically distanced radiating elements, which have the same or different polarizations and preferably are rotated by 45° to each other.

The antenna or base cells preferably comprises at least four transmission paths and/or four receiving paths, which are linked with two similar and preferably identical radiating elements, wherein the two radiating elements are preferably arranged such that they are rotated relative to each other by a particular angle, more preferably by 45°.

Alternatively, the antenna or base cell can have at least eight transmission paths and/or eight receiving paths, which are linked with four similar and preferably identical radiating elements, wherein the four radiating elements are preferably arranged such that they are rotated relative to each other by a particular angle, more preferably by 45°.

The antenna or base cell preferably comprises at least four transmission paths and four receiving paths as well as at least two radiating elements for the transmission paths and at least two radiating elements for the receiving paths. Likewise, two similar and preferably identical, physically distanced radiating elements, which are rotated by 45° relative to each other, can be used for the receiving paths. Alternatively, the antenna or base cell can have at least eight transmission paths or eight receiving paths.

The antenna according to the invention is preferably an active antenna. In particular, boosters can be arranged in the receiving and/or transmission paths. In this case, at least one separate booster is allocated to each receiving and/or transmission path. If appropriate, a plurality of boosters can also be allocated to a transmission path and/or a receiving path. In particular, a booster can be assigned to each resonance frequency range of a radiating element. Therefore, if a radiating element has multiple resonance frequency ranges, preferably multiple boosters can be assigned to it. The use of filters with low selectivity and/or edge steepness is made possible, in turn, by the interval between the resonance frequency ranges of a radiating element.

Also preferably, the transmission power per booster can be less than two watts.

Furthermore, each of the boosters can be linked to the radiating elements. These can preferably be low-quality filters, especially since the transmission and receiving paths will be separated and preferably narrow-band radiating elements will be used.

The radiating elements of an antenna according to the invention can be arranged on a common printed circuit board, wherein the radiating elements are preferably fed by stripline sections arranged on the printed circuit board. For this purpose, preferably all radiating elements of the antenna according to the invention are arranged on one common printed circuit board.

Alternatively or additionally, the radiating elements of the antenna according to the invention, and preferably all radiating elements of the antenna according to the invention, are arranged in front of a common reflector.

In an active configuration of the antenna, the boosters and/or filters in a first embodiment can be arranged on the same printed circuit board on which the radiating elements are also arranged. A multi-layer printed circuit board is preferred for this purpose. In a second embodiment, however, a separate assembly can be provided, on which the electronics and especially the boosters and/or filters are arranged and which is connected to the assembly supporting the radiating elements by a coaxial cable, for example. In this case, at least one waveguide is preferably associated with each radiating element.

According to the invention, dielectric bodies with or without electro-plating can be used as radiating elements.

Furthermore, the dielectric bodies can be arranged on a support. The support can primarily be a mechanical support for the radiating elements.

A dielectric support for the radiating element can further be provided. In particular, the antenna can be equipped with a dielectric plate, on which the dielectric resonators are applied or which has recesses in the vicinity of the dielectric resonators, through which the dielectric resonators pass. The dielectric plate is preferably disposed parallel to the printed circuit board, on which the radiating elements and in particular the dielectric resonators are arranged, The dielectric plate here can be used to expand the bandwidth of the dielectric radiating elements. The dielectric material of the dielectric plate preferably has a lower relative permittivity than the dielectric material of the dielectric resonators. Alternatively or additionally, it is also possible to use elements, especially resonators with a lower relative permittivity or other technologies for expanding broadband and/or increasing the quality or edge steepness of the electric resonators.

The dielectric radiating elements of the present invention preferably have a parallelepiped dielectric body. The use of parallelepiped dielectric bodies permits the polarizations and frequency ranges of the dielectric radiating element to be adjusted more easily.

Alternatively or additionally, the dielectric body of a dielectric radiating element can be fed via a stripline and/or a slot arranged below the dielectric body.

The antenna can have a housing, in particular a closed and/or weather-resistant housing, so that the antenna can be deployed outdoors for a mobile telecommunication base station.

The resonance frequency ranges of the radiating elements that are used according to the invention are initially not further restricted. However, the resonance frequency range(s) of the radiating elements is or are preferably between 1 GHz and 35 GHz.

Furthermore, the resonance frequency range(s) can lie in one or more of the following ranges: 1.650 GHz-2.750 GHz; 3 GHz-5 GHz; 4.5 GHz-7.5 GHz and 21 GHz-35 GHz. Here a single radiating element preferably has at least two resonance frequency ranges, which are both in one of these ranges.

In particular, a radiating element can have at least two resonance frequency ranges lying in a common frequency range, which is not larger than 50% of its center frequency.

These frequency ranges are not covered by the resonance frequency ranges of one single radiating element, though.

Instead, the individual resonance frequency range(s) of the radiating elements preferably has or have a maximum width of less than 20%, more preferably less than 10%, most preferably less than 5% of the respective center frequency of the resonance frequency range.

In addition to the radiating elements described above, a possible development of the invention provides that the antenna according to the invention can have further radiating elements, which are preferably arranged between the radiating elements described above. The further radiating elements are preferably arranged together with the radiating elements on a common printed circuit board or are integrated into a printed circuit board that supports the radiating elements.

These further radiating elements preferably have a higher resonance frequency range than the radiating elements described above, wherein it is further preferred that the center frequency of the lowest resonance frequency range of the further radiating elements be larger than the center frequency of the highest used resonance frequency range of the radiating elements according to the invention and preferably more than 1.2, more preferably more than 1.5, even more preferably more than 1.8, most preferably more than 2.0 the center frequency of the highest used resonance frequency range of the radiating elements.

In one possible embodiment, the further radiating elements can be dielectric resonators with a lower volume, wherein the volume of the further radiating elements is preferably less than 40%, more preferably less than 20%, most preferably less than 10% of the largest radiating elements.

Alternatively or additionally, the further radiating elements can be configured as printed circuit board radiating elements, wherein these are especially patch antennas and/or slot antennas and/or radiating structures that are integrated into the printed circuit board that feeds the radiating elements.

Apart from the claimed antenna, the present invention further comprises a base station with an antenna, as is described above. In particular, the antenna in this case can be configured according to the first and/or the second aspect and/or according to the first or the second embodiment of the present invention.

The base station according to the invention preferably comprises a control system with at least two operating modes, wherein the radiating elements can be operated separately from each other and/or individually in a first operating mode and can be interconnected into one or more groups in a second operating mode. It is operated in the first and second operating mode preferably in the way that has already been described above with respect to the antenna according to the second aspect of the present invention.

In particular, the radiating elements of different base cells can be used for different communications channels and/or separate high-frequency signals in the first operating mode. Alternatively or additionally, the radiating elements of different base cells with the same polarization can be used for the same communications channel and/or with a common, possibly phase-shifted high-frequency signal in the second operating mode. Moreover, the amplitude can also be controlled individually for the individual radiating elements within a group. The first operating mode thus makes a multitude of different communications channels available. On the other hand, beam-forming or beam-steering applications are possible in the second operating mode. The system and group intervals according to the invention are designed for operation in both the first and the second operating modes here. The control system of the base station preferably permits a multitude of different operating modes. Furthermore, the operating modes preferably allow different interconnections among the individual radiating elements.

The antenna of the base station is preferably configured in the manner already described above in greater detail with respect to the antennas according to the invention. It is also preferred that the control system of the base station implement the functions already described above.

The control system of the base station is preferably linked with the boosters of the antenna according to the invention. The operating modes are then preferably controlled by digital beam-forming.

The base station can further comprise a first and a second antenna. Preferably, the first antenna has only transmission paths and the second antenna only receiving paths. Alternatively or additionally, the first antenna can comprise one and preferably a plurality of base cells with four transmission paths, and the second antenna can comprise one and preferably a plurality of base cells with four receiving paths. In particular, the antennas and/or base cells are constructed in the manner described above in greater detail.

Apart from the antenna and the base station according to the invention, the present invention further comprises a set with at least one antenna, as is described above. In particular, the set can comprise a first and a second antenna. Preferably, the first antenna has only transmission paths and the second antenna only receiving paths. Alternatively or additionally, the first antenna can comprise one and preferably a plurality of base cells with four transmission paths, and the second antenna can comprise one and preferably a plurality of base cells with four receiving paths. In particular, the antennas and/or base cells are constructed in the manner described above in greater detail.

Apart from the antenna and the base station according to the invention, the present invention further comprises a method for operating an antenna and/or a base station, as are described above. One or more radiating elements, and in particular one or more radiating elements of different base cells, are preferably operated separately from each other and/or individually in a first operating mode, and are interconnected into one or more groups in a second operating mode.

The method according to the invention is preferably performed in the manner already described above in greater detail with respect to the antenna and the base station according to the invention.

The present invention will now be described in greater detail with the aid of exemplary embodiments and drawings.

The following is shown:

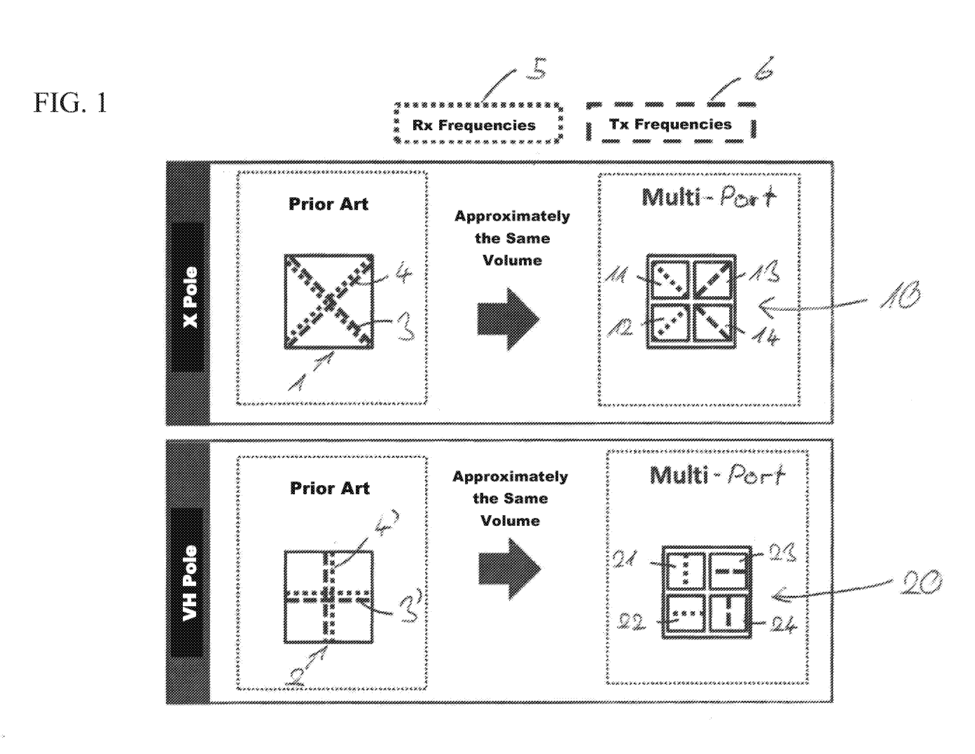

FIG. 1: two variants of a first embodiment of an antenna and a base cell according to the invention in a schematic diagram, compared with a corresponding base cell and/or antenna according to the prior art,

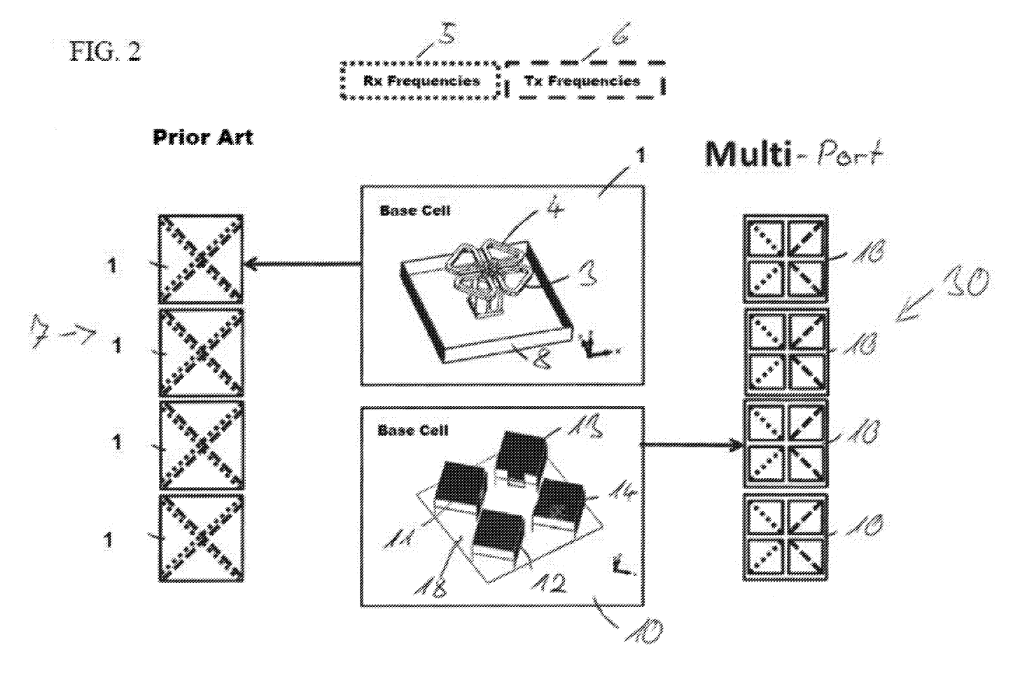

FIG. 2: an embodiment of an antenna according to the invention with a plurality of base cells according to the first embodiment in a schematic diagram, compared with a corresponding antenna with a plurality of base cells according to the prior art,

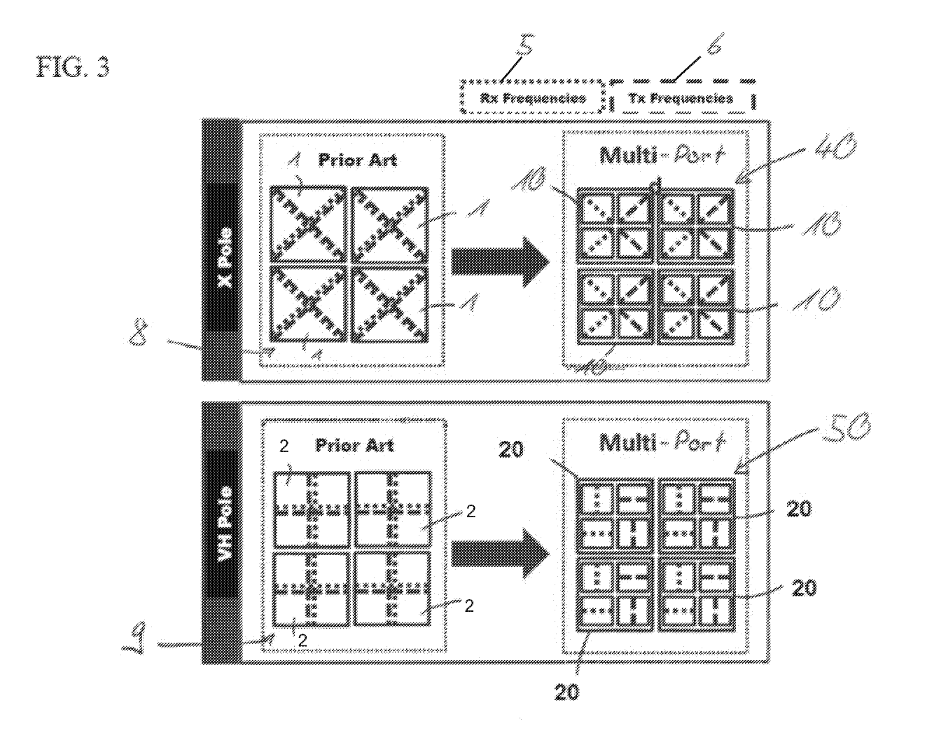

FIG. 3: a further embodiment of an antenna according to the invention with a plurality of base cells according to the first embodiment, which are arranged next to each other both horizontally and vertically, in a schematic diagram, compared with a corresponding antenna with a plurality of base cells according to the prior art,

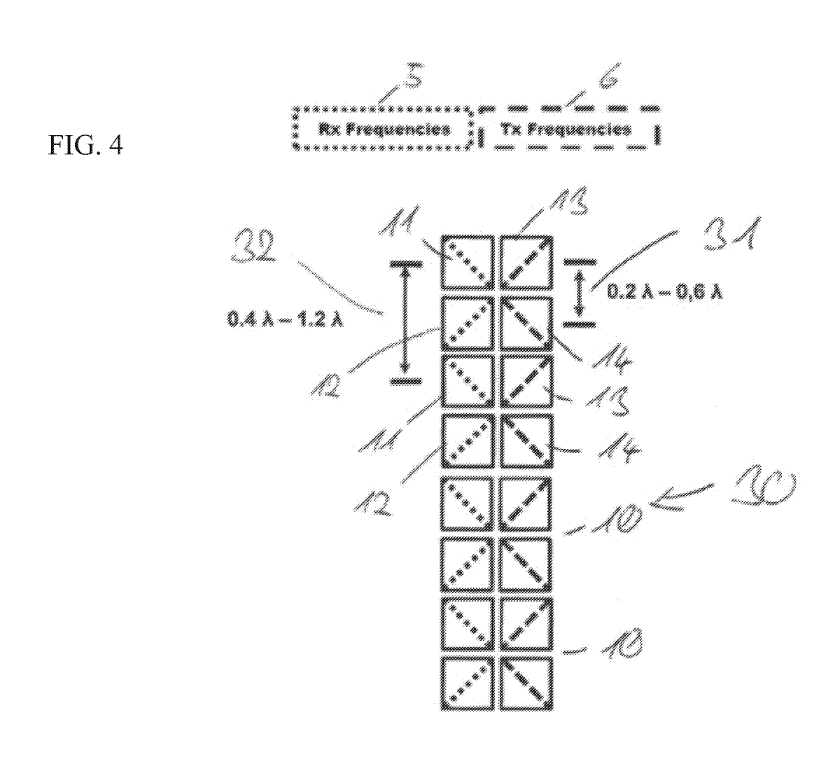

FIG. 4: an embodiment of an antenna according to the invention with a plurality of base cells according to the first embodiment in a schematic diagram, wherein the relevant system intervals are indicated,

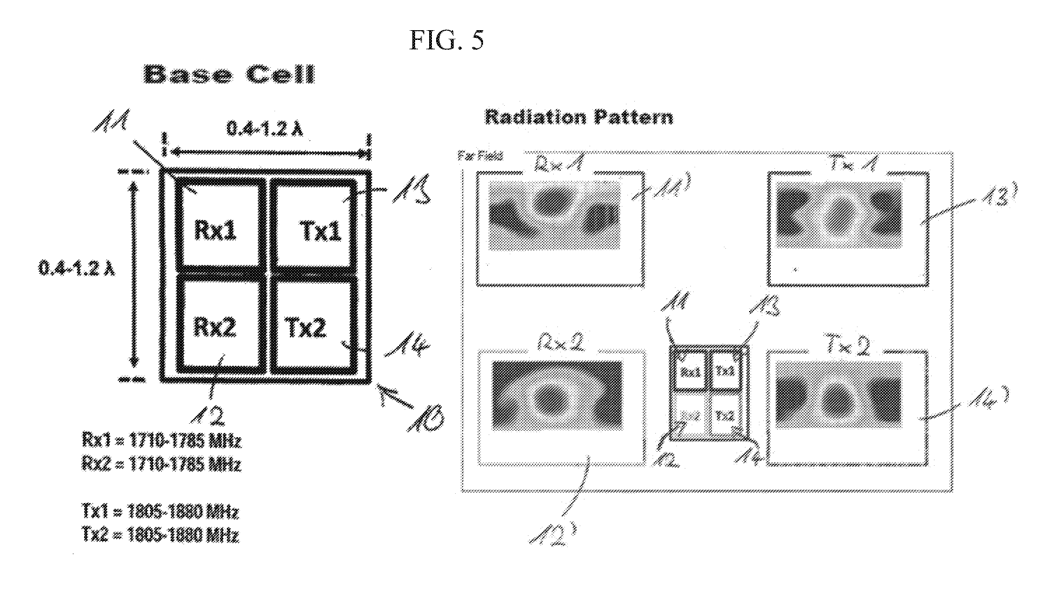

FIG. 5: an embodiment of an antenna according to the invention and a base cell according to the first embodiment in a schematic diagram with the far field radiation patterns of the individual radiating elements,

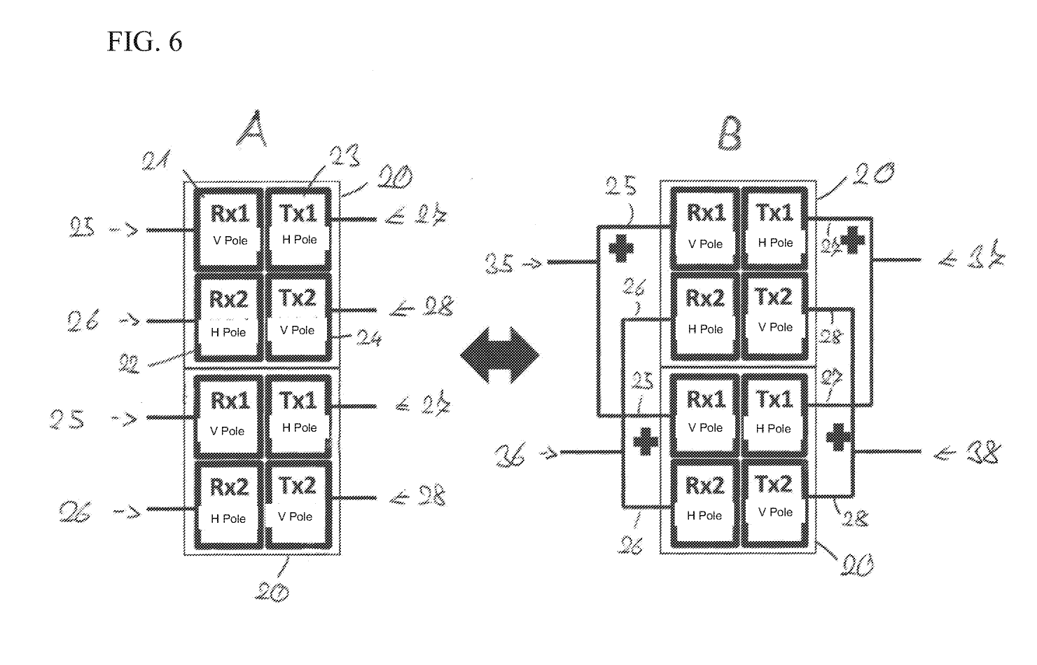

FIG. 6: a schematic diagram of two operating modes of a claimed embodiment of an antenna with at least two base cells according to the first embodiment, wherein the radiating elements of the base cells are operated separately in a first operating mode and are interconnected into groups in the second operating mode,

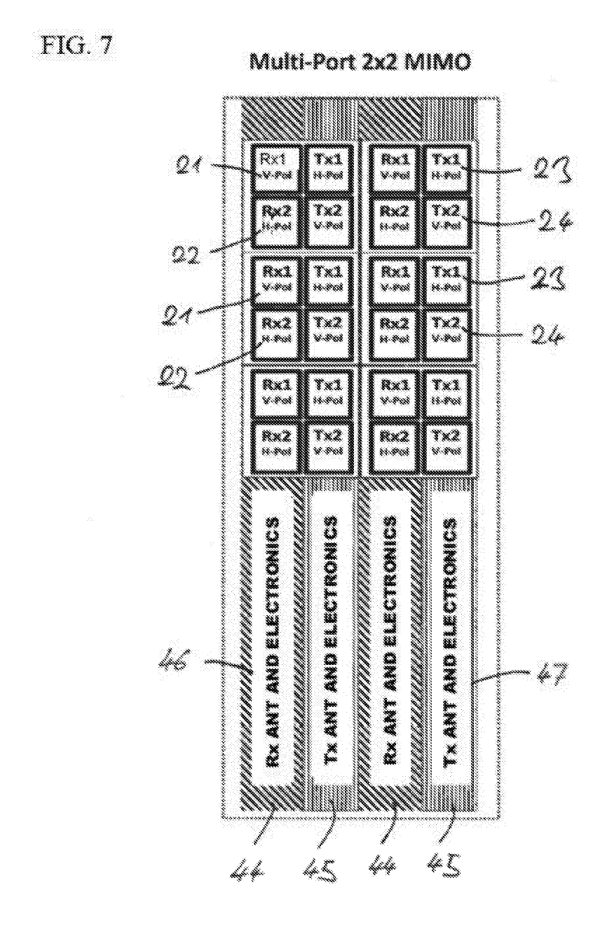

FIG. 7: an embodiment of an antenna according to the invention with a plurality of base cells according to the first embodiment in a schematic diagram, wherein the arrangement of the electronics in columns for the transmission and the receiving paths is shown,

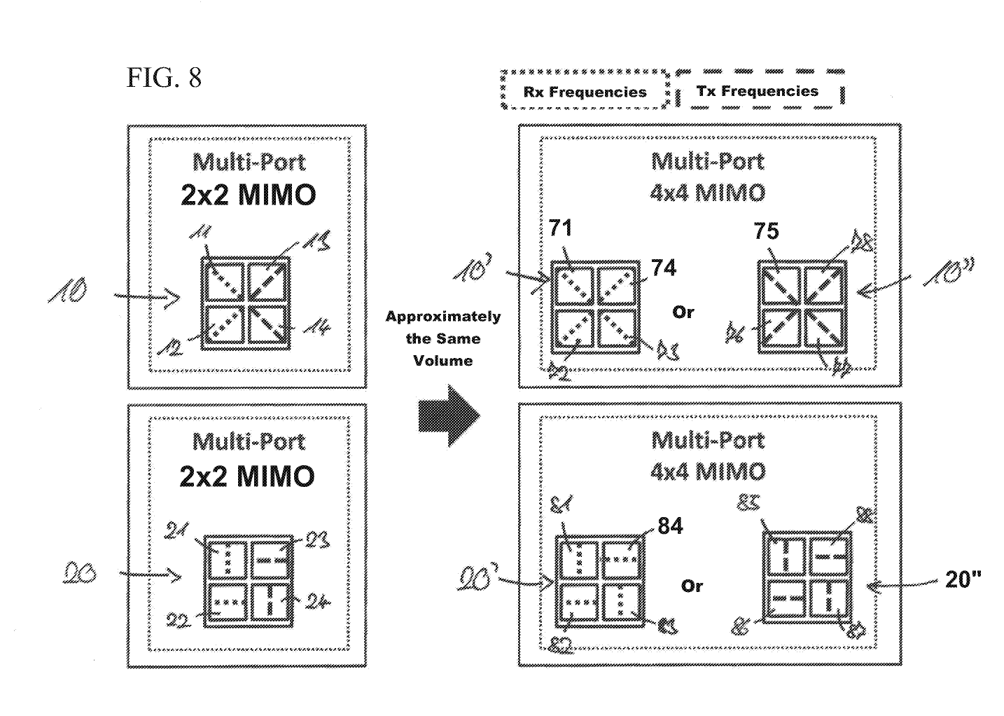

FIG. 8: four variants of a second embodiment of an antenna and a base cell according to the invention in a schematic diagram,

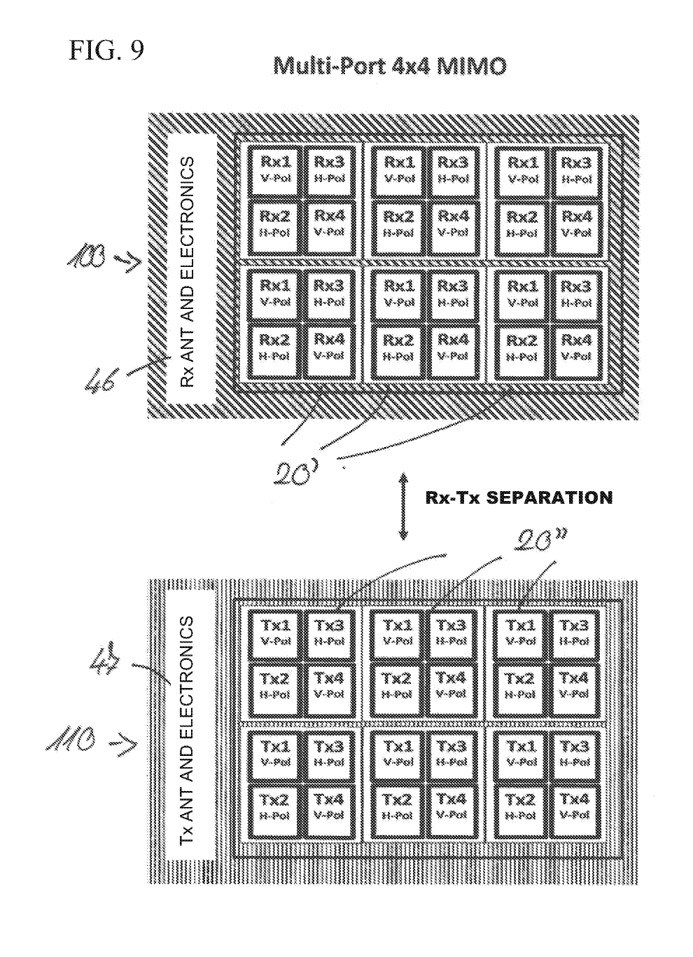

FIG. 9: an embodiment of an antenna according to the invention with a plurality of base cells according to the second embodiment in a schematic diagram, wherein two separate antennas are used for the transmission and the receiving paths is shown,

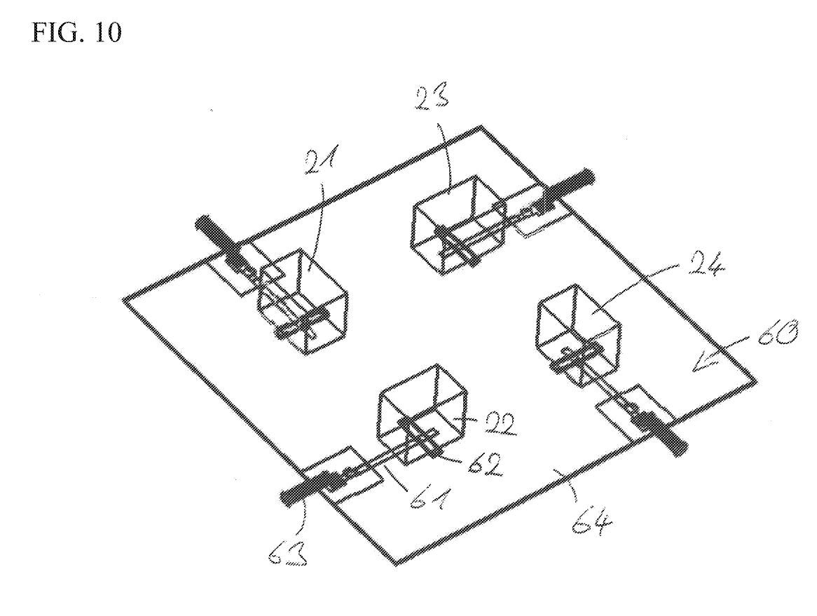

FIG. 10: a perspective view of a first concrete embodiment of an antenna according to the invention,

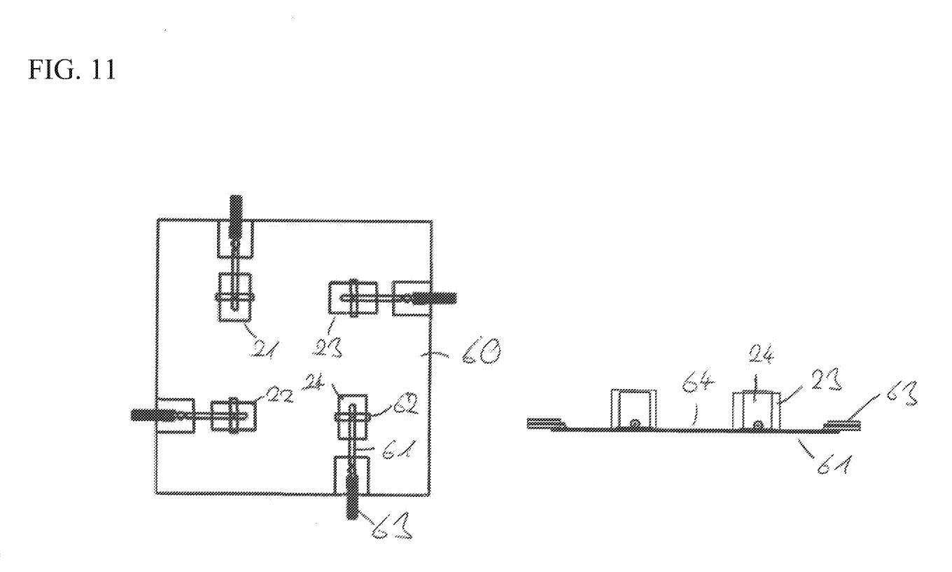

FIG. 11: the embodiment shown in FIG. 10 in atop view and in a side view,

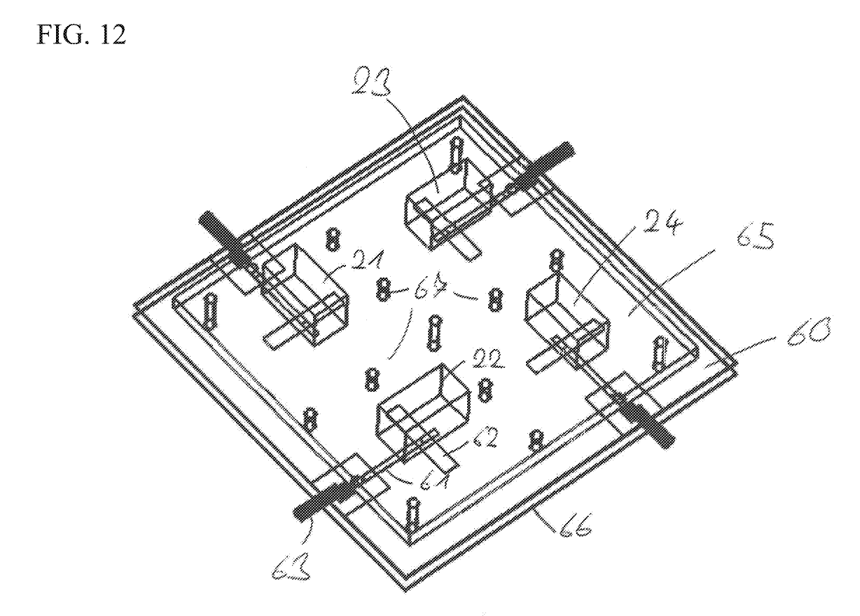

FIG. 12: a perspective view of a second concrete embodiment of an antenna according to the invention,

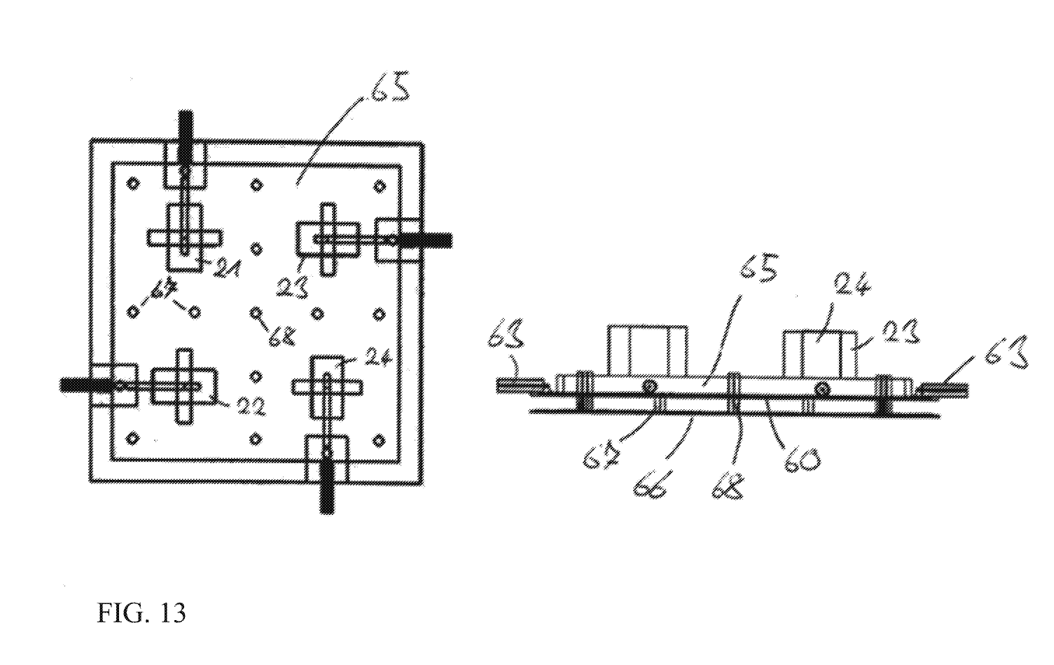

FIG. 13: the embodiment shown in FIG. 12 in a top view and in a side view,

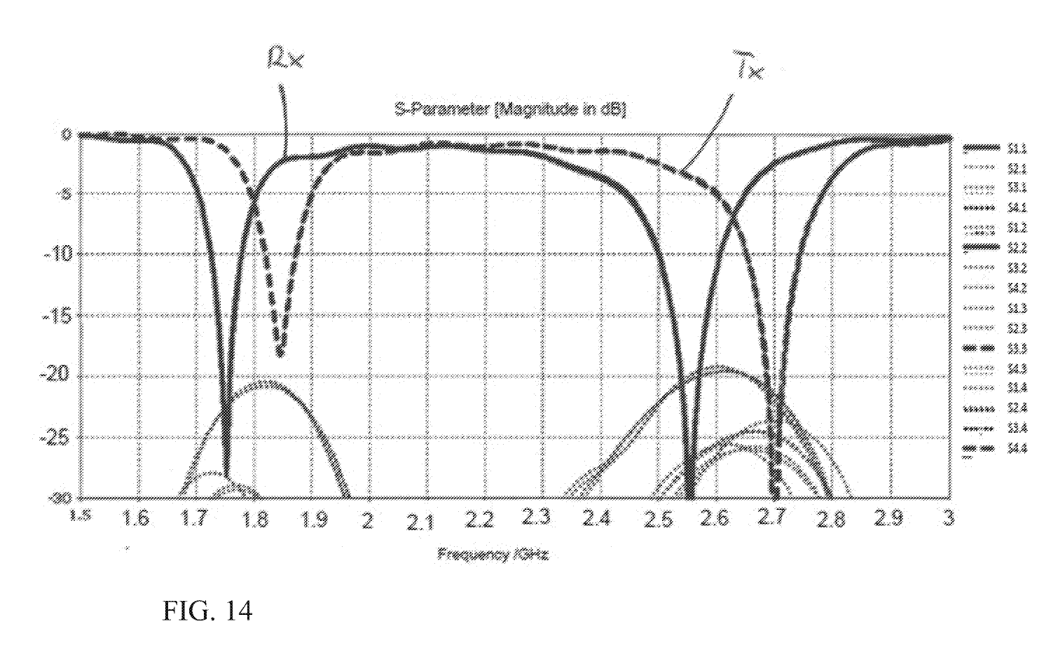

FIG. 14: a frequency diagram (S parameter) of two radiating elements according to the invention, each with two separate resonance frequency ranges, and

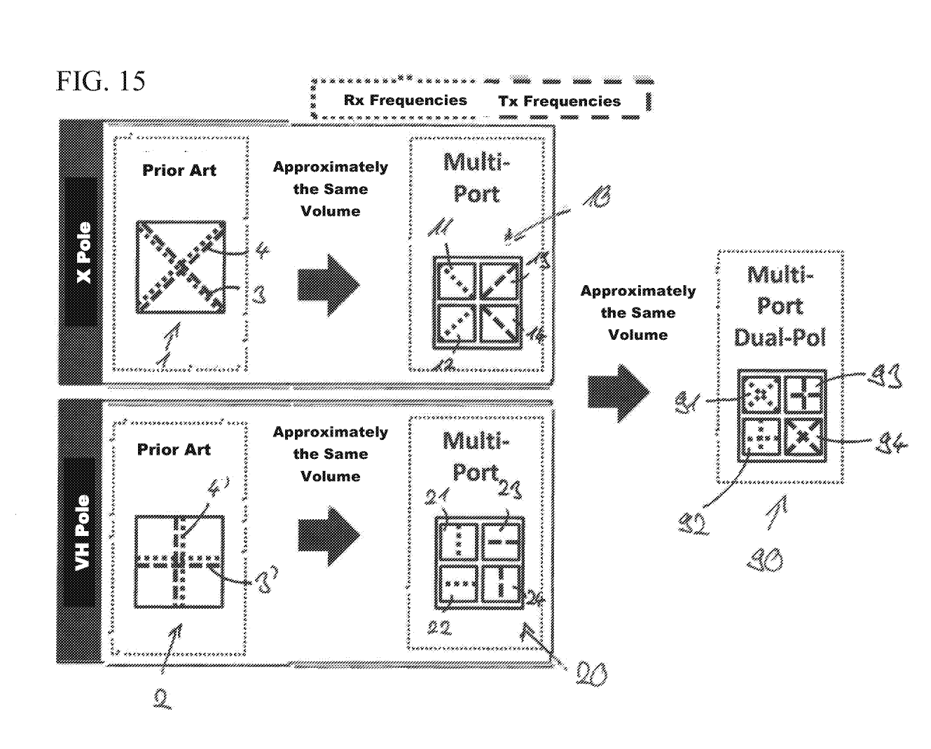

FIG. 15: a third embodiment of an antenna and a base cell according to the invention in which dual-polarized radiating elements are used, in a schematic diagram, compared with an antenna according to the prior art and an antenna according to the first embodiment, and

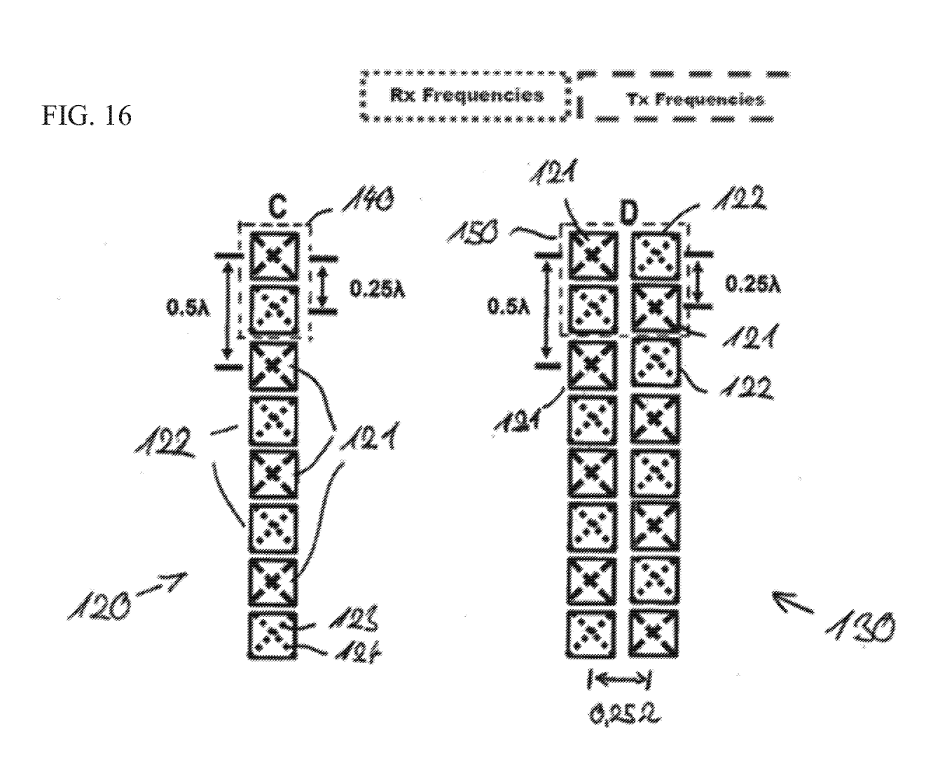

FIG. 16: a fifth embodiment of an antenna and a base cell according to the invention in which dual-polarized radiating elements are used, in a schematic diagram.

The present invention provides a multi-port antenna or multi-port base cell for a multi-column antenna, which avoids the complexity in conventional antennas in terms of the filters and duplexers used as well as the associated losses and which additionally permits a flexible deployment with regard to the interconnection of the individual radiating elements.

FIG. 1 shows two variants of a first embodiment of a multi-port antenna or multi-port base cell according to the invention compared with a corresponding base cell according to the prior art. The use of X-pole radiating elements is shown in the upper row, and the use of vertically and horizontally polarized radiating elements is shown in the lower row. The dotted lines here represent the receiving frequencies 5, and the dashed lines represent the transmission frequencies 6.

In the first embodiment of the present invention, a multi-port antenna 10 and 20 is used instead of an individual dual-polarized radiating element 1 and 2, in which the two polarizations 3, 3′ and 4, 4′ have the same center point and are used for transmitting and receiving, respectively. Said multi-post antenna has four individual radiating elements 11-14 and 21-24, wherein two radiating elements 11, 12 and 21, 22 are employed for receiving and two radiating elements 13, 14 and 23, 24 are employed for transmitting. The two radiating elements 11, 12 and 21, 22 that are used for transmitting have polarizations that are orthogonal to each other and are arranged at a distance from each other. Similarly, the two radiating elements 13, 14 and 23, 24 that are used for transmitting are also arranged at a distance from each other and have polarizations that are orthogonal to each other. In particular, there is a defined interval between the center points of the respective radiating elements.

In the antenna shown in the upper column 10, each of the radiating elements 11-14 has a polarization at an angle of 45° to the vertical. In the multi-port antenna shown in the lower row, by contract, the first radiating element 21 for the receiving frequencies is polarized vertically, while the second radiating element 22 for the receiving frequencies is polarized horizontally. Similarly, the first radiating element 23 for the transmission frequencies is polarized horizontally, while the second radiating element 24 for the transmission frequencies is polarized vertically.

The multi-port antennas and multi-port base cells 10 and 20 according to the invention have approximately the same volume as the antennas and base cells in the prior art. According to the invention, it thus does not simply involve beam reduction. Rather, a new core cell is installed, with two elements for transmission and two elements for receiving.

The two radiating elements 11, 12 and 21, 22 for receiving preferably have the same resonance frequencies or are employed to receive in the same band. In particular, similar and preferably identical radiating elements, which are arranged such that they are rotated by 90° relative to each other, can be utilized for the two radiating elements. Therefore, with the exception of the orthogonal polarizations, the two radiating elements thus have the same and preferably identical receiving properties.

Similarly, the two radiating elements 13, 14 and 23, 24 for transmission can have the same resonance frequencies or can be employed to transmit in the same band. In particular, similar and preferably identical radiating elements, which are arranged such that they are rotated by 90° relative to each other, can also be utilized for the two radiating elements in this instance.

The use of different radiating elements for transmission and receiving paths, as claimed in the invention, further allows the respective radiating elements to optimize their transmitting and receiving performance. In particular, the radiating elements that are assigned to the transmission frequencies can have a different resonance frequency range from the radiating elements that are assigned to the receiving frequencies.

The spaced-apart arrangement of all four radiating elements additionally permits improved MIMO and beam-forming properties of the antenna and base cell.

The antenna according to the invention is preferably an active antenna, in which each radiating element is provided with at least one booster of its own. In particular, each transmission path includes at least one transmitter stage, and each receiving path includes at least one receiving amplifier. In this case, frequency-specific and/or narrow-band radiating elements are preferably used, so that the boosters can be linked with the radiating elements via simple band-pass filters or high-pass filters with low selection. In so doing, highly selective filters with their corresponding size and cost can be omitted.

According to the first aspect of the invention, dielectric radiating elements are used in order to permit a small individual radiating element interval between the individual radiating elements. Here the interval between the center points of adjacent radiating elements in both the horizontal and vertical directions measured 0.2λ to 0.6λ, wherein λ stands for the wavelength of the center frequency of the lowest resonance frequency band of the radiating elements involved. The individual radiating element interval is preferably from 0.2 to 0.3λ relative to the wavelength of the center frequency λ of the lowest resonance frequency band of the radiating elements involved. Preferably, radiating elements with a dielectric resonator are used as the radiating elements. However, the dielectric radiating elements according to the invention can be dipoles, patches, monopoles or PIFA antennas that are reduced in size with the aid of dielectrics.

According to the third aspect, which is combined with the first aspect in the embodiment, multiple multi-port base cells, such as those shown in FIG. 1, can be combined into one antenna. This kind of multi-port antenna 30 according to the invention, consisting of multiple multi-part base cells 10 according to the invention, is itself compared with a corresponding antenna 7 according to the prior art in FIG. 2. As is shown in FIG. 2, a plurality of base cells 10 according to the first embodiment are arranged vertically one above the other. The base cells are constructed as already described with respect to the base cell 10 depicted in FIG. 1. According to the invention, the arrangements of radiating elements in the respective base cells thus repeated in an identical manner.

A perspective view of the base cells 1 according to the prior art and the base cells 10 according to the present invention is shown in the center of FIG. 2, wherein the first aspect of the present invention is also implemented here. The base cell 10 according to the present invention contains four dielectric radiating elements 11-14, which are arranged on a common reflector 18. Radiating elements with a dielectric resonator are used as the radiating elements in this embodiment.

Two further embodiments 40 and 50 of a multi-port antenna as claimed in the invention consisting of a plurality of multi-port base cells 10 and 20 as claimed in the invention are shown in FIG. 3 in accordance with the first embodiment. In the embodiments shown in FIG. 3, the antenna has an arrangement of base cells both in the vertical and in the horizontal direction. In the upper column, the multi-port base cells 10 according to the invention are shown in X-pole radiating elements; in the lower row, the base cells 20 according to the invention are shown with vertically and horizontally polarized radiating elements.

In the embodiment, the antenna has two columns and two rows, each of which is formed from base cells. Naturally, antennas with proportionally more columns and/or proportionally more rows are also conceivable. The comparison with the corresponding radiating elements 8 and 9 of the prior art shows, in turn, that the base cells according to the invention can replace the radiating elements from the prior art in terms of installation space.

FIG. 4 again shows the multi-port antenna 30 presented in FIG. 2 with multiple base cells 10 arranged vertically one above the other according to the first embodiment. Each base cell consists of four radiating elements 11-14, wherein the transmission and receiving paths and the polarizations are separated here, as is described above. FIG. 4 then depicts the system spacing in greater detail.

The vertical interval 31 between the individual radiating elements is between 0.2λ and 0.6λ, wherein the interval between the center points of the respective radiating elements is measured and wherein λ stands for at least the wavelength of the center frequency of the lowest resonance frequency range of the radiating elements involved and preferably the wavelengths of the center frequencies of all utilized resonance frequencies range of all radiating elements involved. The same interval also applies in the horizontal direction. The same or identical radiating elements of adjacent base cells have twice the individual radiating element interval, i.e. an interval 32 of between 0.4λ and 1.2λ. The interval between similar or identical radiating elements of adjacent base cells is shown in the vertical direction in FIG. 4. If multiple base cells are arranged next to each other horizontally, the interval is preferably likewise double the individual radiating element interval, i.e. between 0.4λ and 1.2λ.

As is shown in greater detail in FIG. 5, the far field diagrams of the individual radiating elements 11-14 of a base cell 10 according to the invention have a somewhat different form in the first embodiment as a result of the asymmetrical metal environment. FIG. 5 shows the base cell 10 according to the invention with two radiating elements 11 and 12 for the receiving frequencies and two radiating elements 13 and 14 for the transmission frequencies. As was indicated in FIG. 5, the two radiating elements 11 and 12 are used for the same frequency band of 1.710 to 1.785 MHz. The two transmitting radiators 13 and 14 are used for the same frequency band between 1.805 and 1.880 MHz. Thus similar and preferably identical radiating elements, which are rotated by 90°, are used for the two radiating elements 11 and 12, and similar and preferably identical radiating elements, which are rotated by 90° relative to each other, are likewise used for the two transmitting radiators 13 and 14. The radiating elements for receiving (Rx1 and Rx2) and the radiating elements for transmission (Tx1 and Tx2) thus have different resonance frequency ranges that are optimized for the respective frequencies. In particular, the resonance frequency ranges of the Tx radiating elements and of the Rx radiating elements are so narrow that, although they cover the transmission frequency range or the receiving frequency range of a mobile telecommunication frequency band, they do not cover both ranges. Furthermore, the respective center frequencies of the resonance frequency ranges are offset from each other.

The respective radiation patterns 11′-14′ for the radiating elements 11-14 are shown on the right side of FIG. 5, wherein it is the far field of the radiating element in each case.

The different radiation patterns result in better decoupling between the individual radiating elements 11-14 of the base cell 10. The invention utilizes this decoupling, i.e. the asymmetry of the far field or the “squint” of the far field, to achieve better decoupling values among the individual radiating elements. In particular, this results in improved decoupling between adjacent individual radiating elements, where the decoupling is otherwise limited by the small interval and the polarization. This occurs at the expense of far field symmetry or, in MIMO applications, at the expense of differences in performance among the signal paths.

If multiple base cells are used, as in the third and fourth aspects of the present invention, then they can both be fed individually via the power supply network and be interconnected in any desired way. In particular, a group arrangement, in which similar or identical radiating elements of adjacent base cells are interconnected, makes it possible here to perform vertical and/or horizontal beam-forming and/or beam-steering. Moreover, skillful interconnection can also bring about a balance in the far field symmetry of the individual radiating elements in the base cells. In particular, proportionate powering of the individual elements with different phases and/or amplitudes can be carried out here.

According to the invention, the asymmetry of the base cell thus contributes to the decoupling of adjacent radiating elements when the individual radiating elements are single-fed, but it can be balanced out by skillful feeding when they are interconnected (e.g. beam-forming or interleaving). This is especially advantageous in 4G and 5G transmission methods, since the elements should be fed individually or interconnected depending on the environment (urban or rural) and degree of utilization (capacity or coverage).

Two such operating modes A and B are represented in FIG. 6 on the basis of an antenna according to the invention consisting of two base cells 20. Each of the base cells, in turn, has four radiating elements 21-24. The base cell 20 is the base cell 20 shown in FIG. 1. according to the first embodiment, with vertically and horizontally polarized radiating elements. A base cell 10 with X-pole radiating elements could also be used in the same way.

In the operating mode A seen on the left in FIG. 6, the transmission paths 27 and 28 and the receiving paths 25 and 26, which are associated with the radiating elements 23, 24 and 21, 22 of each base cell (and are not depicted in greater detail here), are operated separately. This kind of operating mode can be employed in particular when more transmission capacity is required and it is therefore typical for urban areas.

In the operating mode B seen on the right in FIG. 6, on the other hand, similar or identical radiating elements of adjacent base cells are interconnected in groups. As is shown on the right side of FIG. 6, the receiving paths 25 of adjacent base cells are connected together to form a common receiving path 35, and receiving paths 26 are connected together to form a common receiving path 36. Similarly, the transmission paths 27 of adjacent base cells are connected together to form a common transmission path 37, and transmission paths 28 are connected together to form a common transmission path 38. This type of interleaving permits beam-forming in particular, wherein the individual interconnected transmission and receiving paths are preferably operated with different phases and possibly with different amplitudes for this purpose. In particular, an operating mode such as this can be employed when the mobile ratio networks require more coverage, typically in the countryside.

Of course, significantly more complex interleaving of the individual elements are also possible, especially when using an antenna with multiple base cells that are arranged both in horizontal and in vertical rows. There can thus be a multitude of different operating modes, in which the radiating elements are interconnected and operated in different constellations.

The individual radiating element interval between the individual radiating elements, when optimized for the two operating modes shown in FIG. 6, is then less than or equal to 0.25λ, and so an effective interval of less than or equal to 0.5λ is created between similar or identical radiating elements of adjacent base cells. The interval of less than or equal to 0.25λ is advantageous for single-feeding, while the interval of less than or equal to 0.5λ is optimal for beam-forming or beam-steering.

Nevertheless, an interval this small can lead to insufficient isolation between the individual radiating elements. The claimed individual radiating element interval of 0.2λ to 0.6λ between two adjacent radiating elements or the claimed group interval of 0.4λ to 1.2λ between the radiating elements of adjacent base cells thus represents a compromise between the optimal system intervals for single-feeding, beam-forming, beam-steering and a sufficient decoupling of the radiating elements. This is true particularly when the radiating elements do not use only one frequency, as is explained in greater detail below.

Preferably, the vertical and horizontal individual radiating element interval between the radiating elements is between 0.2λ and 0.3λ, wherein λ stands for the wavelength of the center frequency of the lowest resonance frequency range of the radiating elements involved, and the vertical and horizontal group interval of similar or identical radiating elements of adjacent base cells is preferably between 0.4λ and 0.6λ, wherein λ stands for the wavelength of the center frequency of the lowest resonance frequency range of the radiating elements involved.

If the radiating elements have multiple resonance frequency bands that are used to cover different mobile frequency bands, as is detailed below, then the vertical and horizontal individual radiating element interval between the radiating elements for the center frequencies of all employed resonance frequency bands of the radiating elements is preferably between 0.2λ and 0.6λ, and the vertical and horizontal group interval of similar or identical radiating elements of adjacent base cells is preferably between 0.4λ and 1.2λ.

It is also preferred that the vertical and horizontal individual radiating element interval between the radiating elements for the center frequencies of the highest employed resonance frequency band of the radiating elements can be between 0.4λ and 0.6λ, and the vertical and horizontal group interval of similar or identical radiating elements of adjacent base cells can be between 0.8λ and 1.2λ.

According to the invention, there is at least 10 dB, more preferably 15 dB of isolation between adjacent radiating elements. In particular, an isolation of 10 dB and preferably 15 dB can be achieved between the receiving and transmission paths, both for single-feeding and interconnection. Moreover, the isolation between adjacent radiating elements and/or between receiving and transmission paths can also be more than 20 dB or 25 dB.

The power supply network can feed power the individual antenna ports and radiating elements singly and/or interconnect them with any desired phase and amplitude. In one embodiment, the respective operating mode can be controlled digitally, e.g. by digital beam-forming and/or by means of a digital beam-forming processor. In this way, the antenna can be operated in an appropriate operating mode, depending on the current requirements for the base station.

In the first embodiment, the two Rx radiating elements 11, 12 and 21, 22 of a base cell according to the invention are preferably arranged in a column or a row of the base cell, as are the two Tx radiating elements 13, 14 and 23, 24. They are preferably arranged in columns, as is shown in FIG. 1 through 6. As seen in FIG. 7, this offers the advantage that the Rx antennas 21, 22 with their connectors and/or electronics 46 and the Tx antennas 23, 24 with their connectors and/or electronics 47 can likewise be arranged column by column in alternating columns 44 and 45 of the antenna. This leads to improved decoupling of the transmission and receiving paths and a simplified design of the antenna.

The right-hand half of FIG. 8 shows a second embodiment of a base cell according to the invention, by means of which an even large physical separation of the transmission paths and the receiving paths is possible, compared with the first embodiment in multiple variants shown on the left.

In contrast to the first embodiments of a base cell 10 and 20 shown on the left, which have two Rx radiating elements 11, 12 and 21, 22 and two Tx radiating elements 13, 14 and 23, 24, base cells 10′ and 20′ have only Rx radiating elements 71-74 and 81-84, and base cells 10″ and 20″ have only Tx radiating elements 75-78 and 85-88.

Thus a base cell according to the second embodiment has either four Tx radiating elements or four Rx radiating elements. It follows that the base cells according to the second embodiment have only transmission paths or only receiving paths and are therefore configured either as a receiving base cell 10′ and 20′ or as a transmission base cell 10″ and 20″.

A receiving base cell 10′ and 20′ comprises at least four receiving paths, which are linked with the four Rx radiating elements 71-74 and 81-84. On the other hand, a receiving base cell 10″ and 20″ comprises at least four transmission paths, which are linked with the four Tx radiating elements 75-78 and 85-88. As in the first embodiment, however, an Rx radiating element can also be linked with a plurality of receiving paths, and a Tx radiating element can be linked with a plurality of transmission paths, especially when radiating elements are employed that use a plurality of resonance frequency bands.

The four radiating elements all have polarizations that are rotated by 90° relative to each other. The polarizations of pairs of radiating elements, which are disposed opposite each other on the diagonals in the embodiment, are thus rotated relative to each other by 180°. This allows the base cells in a first operating mode to be operated like a base cell according to the prior art, wherein the pairs of radiating elements are interconnected with polarizations that are rotated relative to each other by 180°. In a second operating mode, by contrast, these pairs of radiating elements can be operated separately or can be interconnected separately with radiating elements of other base cells.

The polarizations of the Rx radiating elements 71-74 in the receiving base cell 10′ and of the Tx radiating elements 75-78 in the transmission base cells 10″ each have an angle 45° to the vertical and/or horizontal; by contrast, the polarizations of the Rx radiating elements 81-84 in the receiving base cell 20′ and the Tx radiating elements 85-88 in the transmission base cell 20″ have either a horizontal or vertical orientation.

The Rx radiating elements used for the second embodiment thus preferably correspond to the Rx radiating elements also used in the first embodiment, and the Tx radiating elements used for the second embodiment preferably correspond to the Tx radiating elements also used in the first embodiment, wherein four Rx radiating elements or four Tx radiating elements are used in a base cell instead of two Rx radiating elements and two Tx radiating elements.

In particular, all Rx radiating elements in a base cell can be used for the same frequencies and in particular have the same resonance frequency bands and/or the same design. For the Rx radiating elements of a base cell, four similar and preferably identical radiating elements, which are arranged such that they are rotated by 90° relative to each other, can be arranged on the base plate of the antenna.

Likewise, all Tx radiating elements in a base cell can be used for the same frequencies and in particular have the same resonance frequency bands and/or the same design. For the Tx radiating elements of a base cell, four similar and preferably identical radiating elements, which are arranged such that they are rotated by 90° relative to each other, can be arranged on the base plate of the antenna.

As was previously shown for the first embodiment, the radiating elements that are employed as Tx and Rx radiating elements can be radiating elements with a dielectric resonator (DRA). Preferably, the dielectric resonators and feed lines for the resonators within a base cell for the four radiating elements are arranged such that they are each rotated 90° relative to each other. Parallelepiped dielectric resonators are preferably also used here.

The individual radiating element interval between the radiating elements for the first embodiment preferably corresponds to the individual radiating element interval detailed for the first embodiment; the same applies to the group interval among the same or identical radiating elements in adjacent base cells.

An antenna according to the second embodiment preferably comprises a plurality of similar and preferably identical base cells, which are vertically and/or horizontally adjacent to each other, as in the first embodiment.

As is shown in FIG. 9, either a receiving group antenna 100 consisting of multiple receiving base cells 20′ or a transmission group antenna 110 consisting of multiple transmission base cells 20″ is created in this way. Preferably, the electronics of the receiving paths 46 are installed together with the receiving base cells 20′ in a first assembly, while the electronics of the transmission paths 47 are installed together with the transmission base cells 20″ in a second assembly. Even more improved isolation of the transmission and receiving paths is achieved a result of this physical separation of the transmission and receiving paths with the corresponding electronics and associated radiating elements. Here the receiving group antenna 100 and the transmission group antenna 110 can be configured as separate antennas, which can also have a separate housing, if necessary.

FIGS. 10 and 11 then present a first concrete embodiment of a base cell according to the first embodiment in the invention, which has four radiating elements 21-24. The radiating elements are vertically and horizontally polarized radiating elements, and so the base cell corresponds to the base cell 20 shown in FIG. 1. An X-pole base cell then results simply by rotating the entire arrangement by 45°.

The radiating elements 21-24 used here are dielectric resonators, wherein the dielectric resonators in the embodiment are parallelepiped dielectric bodies. Said dielectric resonators are fed with power via striplines 61, which are in turn linked with coaxial connectors 63. The radiating elements and dielectric resonators are arranged on a common printed circuit board 60. The upper side of the printed circuit board 60 has a metal coating 64 with slots 62 disposed below the dielectric resonators. The stripline sections 61, which form the inputs of the respective resonators, are arranged on the lower side or in a different plane of the printed circuit board 60. The stripline sections 61 and the slots 62 in the electro-plated surface 64 are perpendicular to each other, wherein each of intersection points is located directly below a dielectric resonator.

The resonance frequencies of the dielectric radiating elements depend upon the dimensions of the dielectric bodies, and they will be described in greater detail below. The dielectric bodies can have a height, width and length that each lie e.g. in a range between 0.02λ and 0.2λ, wherein λ stands for the wavelength of the center frequency of the lowest resonance frequency band of the respective radiating element. The sum of the length and width is preferably less than 0.2λ so that the dielectric resonators can be easily be arranged next to each other with the individual radiating element interval according to the invention.

Identical dielectric resonators, i.e. dielectric bodies with identical dimensions, are used for the two radiating elements 21 and 22 that are used for receiving. However, the two dielectric bodies are rotated by 90° to each other, as are their power supplies. Two radiating elements with identical resonance frequency ranges but orthogonal polarizations are thereby employed for transmitting. Similarly, identical dielectric resonators, i.e. dielectric bodies with identical dimensions, are used for the two radiating elements 23 and 24 that are used for transmitting. Here, too, the two dielectric bodies and their power supplies are each offset from each other by 90°, and so identical resonance frequency ranges but orthogonal polarizations result. The resonance frequency ranges of the dielectric resonators 21, 22 and 23, 24 are different, though, and they are preferably optimized with respect to the transmission and receiving frequency ranges.

FIGS. 12 and 13 show a further concrete embodiment of a base cell according to the invention, which is based on the embodiment depicted in FIGS. 10 and 11 and additionally has a shared reflector 66 and a dielectric plate 65. The reflector 66 is arranged via spacer elements 67 below the printed circuit board 60 and runs parallel to it. The dielectric plate 65 is arranged on the upper side of the printed circuit board, and the dielectric resonators are applied onto it. The dielectric plate brings about a widening of the resonance frequency bands of the dielectric resonators. The printed circuit board is attached by means of connecting elements 68.

Only one single base cell is shown in the embodiments in FIG. 10 to 13. However, as was explained above, multiple base cells can be arranged next to each other. In particular, a plurality of similar and preferably identical base cells are arranged next to each other with the same individual radiating element interval, which is also applied within a base cell. The base cells can be arranged both vertically and horizontally next to each other.

If multiple base cells are used, then they are preferably not formed by individual elements, as is represented in FIG. 10 to 13. Instead, the radiating elements of different base cells are preferably arranged on the same printed circuit board and, if available, have the same reflector and/or a continuous dielectric plate. According to the invention, the base cells are preferably abstract structural elements that are combined within an antenna without being separated from each other.

The embodiments in FIG. 10 to 13 are embodiments of an antenna or a base cell in the first embodiment according to the invention, in which the antenna or base cell has two transmission paths and two receiving paths and/or two Rx radiating elements and two Tx radiating elements.

Exactly the same concrete design as was described for the first embodiment with the aid of FIG. 10 to 13 can also be utilized for an antenna or base cell according to the second embodiment, in which an antenna or base cell has four transmission paths or four receiving paths and thus four Rx radiating elements or four Tx radiating elements. In this case, only identical dielectric resonators are employed for all radiating elements instead of two different dielectric resonators for the Rx and the Tx radiating elements, as were provided in FIG. 10 to 13. These identical dielectric resonators are then all Rx radiating elements or all Tx radiating elements, depending on their configuration, and have the appropriate resonance frequency ranges.

Just as is shown in FIG. 10 to 13, all of the four dielectric resonators and their feed lines are rotated 90° to each other so that a base cell has four identical radiating elements, which are arranged at angles of 0°, 90°, 180° and 270°, respectively. In this type of base cell, the result is thus two radiating element pairs with radiating elements that are rotated 180° to each other, wherein the two radiating element pairs are offset by 90° to each other. The two radiating elements within a pair such as this can be interconnected in a first operating mode, in which case they substantially correspond to a dipole radiating element according to the prior art, but they can also be operated separately.

In one possible development that is not depicted in the drawings, further radiating elements can be provided on the printed circuit board 60 next to radiating elements 21 to 24 and in particular between radiating elements 21 to 24.

These further radiating elements can be employed to transmit and/or receive in a higher mobile telecommunication frequency band. Owing to the wide frequency spacing, the further radiating elements exert only a minor influence on the radiating elements 21 to 24 according to the invention.

In a possible embodiment, the further radiating elements can likewise be dielectric resonators, but ones with preferably have a significantly smaller volume than the radiating elements 21-24 according to the invention. In particular, the volume can be less than 10% of the volume of radiating elements 21 to 24.

Alternatively or additionally, the further radiating elements can also be configured as printed circuit board radiating elements, wherein these are especially patch antennas and/or slot antennas and/or radiating structures that are integrated into the printed circuit board 60.

As is explained above, the antenna according to the invention is preferably an active antenna, regardless of the embodiment, and so the transmission and receiving paths each have boosters. The transmission and receiving paths can additionally have filters. In one possible configuration, the electronics of the transmission and receiving paths can be arranged on the same circuit board on which the radiating elements are also arranged. In particular, a multi-layer circuit board can be used for this purpose. For example, the electronics can be provided on the rear side of the printed circuit board. Alternatively, however, a separately assembly, particularly a separate printed circuit board, can be provided for the electronics with the boosters and/or filters. Said assembly is then linked to the radiating elements via coaxial lines, as is also the case with the base cells shown in FIG. 10 to 13. In this case, at least one and preferably exactly one connector and/or coaxial line is preferably associated with each radiating element.

The electronics that control the interconnection or separate operating of the transmission and receiving paths either can be considered separate from the electronics of the active antenna or can be integrated into the same assembly. Preferably, the control is carried out digitally, e.g. by digital beam-forming and/or by means of a digital beam-forming processor.

As was previously explained, the dielectric radiating elements according to the invention are narrow-band radiating elements. By using separate narrow-band radiating elements of this type for Rx and Tx, the intermodulation is reduced and additional damping in the duplex filters is avoided. Accordingly, it is possible to rely upon simple filters with low selection instead of highly selective filters. Radiating elements with a dielectric resonator inherently have very narrow bandwidths. Especially since a separate dielectric radiating element is used for every polarization, the bandwidths can be expanded somewhat by using a dielectric plate to cover the entire transmission and receiving range of a mobile telecommunication band.

Furthermore, the invention provides that a further band can be added to the individual radiating elements, in particular a further mode or field distribution. Higher frequencies/modes lend themselves especially well to this purpose.

In particular, an individual radiating element can have two resonance frequency ranges that are spaced relatively far apart in order to cover two mobile telecommunication bands and their respective transmission and receiving ranges over the two resonance frequency ranges.

FIG. 14 shows the frequency diagram of two exemplary radiating elements, of which the first is used for receiving (Rx) and the second for transmission (Tx). The diagram also presents the S parameters. The radiating element Rx utilized for receiving has a first resonance frequency range, which covers the receiving range between 1,710 and 1,785 MHz of band 3, and a second receiving frequency range, which covers the receiving range between 2,500 and 2,570 MHz of band 7. On the other hand, the radiating element Tx utilized for transmitting has a first resonance frequency range, which covers the receiving range between 1,805 and 1,880 MHz of band 3, and a second resonance frequency range, which covers the receiving range between 2,620 and 2,690 MHz of band 7. According to the invention, the Rx radiating elements and the Tx radiating elements thus have narrow resonance frequency ranges, each of which covers either the receiving frequency range (Rx radiating element) or the transmission frequency range (Tx radiating element) of one or more mobile telecommunication frequency bands, but not both.

Radiating elements with more than two resonance frequency ranges can also possibly be used, e.g. with three resonance frequency ranges.

The aforementioned resonance frequency ranges are thus merely an example of the implementation of the present invention. The resonance frequency ranges of the radiating elements that are used according to the invention can also lie in other frequency bands, particularly in the range between 1 GHz and 35 GHz. The use in particular of frequency ranges around 4 GHz and/or 6 GHz and/or 28 GHz is also conceivable. On the whole, the ranges that are utilized can each have a width of less than 50% with respect to these frequencies, wherein each of the resonance frequency ranges exist as a narrow band in these larger ranges.

For instance, the radiating elements can have resonance frequency ranges that lie in one or more of the following ranges: 1.650 GHz-2.750 GHz; 3 GHz-5 GHz; 4.5 GHz-7.5 GHz and 21 GHz-35 GHz. Here a single radiating element preferably has at least two resonance frequency ranges, which are both in one of these ranges.

If the antenna has further radiating elements in addition to the radiating elements according to the invention, as described above, then they preferably have one or more higher resonance frequency ranges. For example, the resonance frequency range(s) of the radiating elements according to the invention can lie in a first of the aforementioned ranges, and the resonance frequency range(s) of the further radiating elements can lie in a higher of the aforementioned ranges.

The radiating elements for that resonance frequency range are preferably linked with a separate booster. Multiple boosters are linked to the radiating element via a frequency multiplexer in particular when there are multiple resonance frequency ranges. Owing to the narrow-band configuration of the resonance frequency ranges and the broad interval between the resonance frequency ranges, however, simple bandpass filters with low selection are used as a multiplexers.

In the embodiments of the present invention that have heretofore been described, separate radiating elements are used both for the transmission and receiving paths and for the orthogonal polarizations. Each radiating element is thus utilized only for transmitting in one polarization, and either for transmitting or receiving. In this case, the base cell has four radiating elements, which preferably form a two-dimensional arrangement of radiating elements, and are arranged in particular with predetermined vertical and horizontal spacing from each other.

By contrast, dual-pole radiating elements 91 to 94 and 91′ to 94′ can be used in a third, fourth and fifth embodiment of the present invention, which is described in greater detail with the aid of FIGS. 15 and 16. The embodiments in FIGS. 1 through 14 can also be implemented with dual-polarized radiating elements. The dual-pole radiating elements are also preferably dielectric radiating elements and especially radiating elements with a dielectric resonator, although these have two separate inputs, by which two different radiation modes can be activated. The two radiation modes of the individual radiating elements differ in terms of polarization and/or frequency. The two radiation modes induced by the connectors preferably have the same resonance frequency range. However, the two radiation modes can possibly also differ in terms of frequency, and so the two connectors of a radiating element can be used, for example, for two different mobile telecommunication frequency bands.

As is shown in detail in FIG. 15, a base cell 1 or 2 according to the prior art can be replaced, in turn, by a base cell 90 according to the invention that has approximately the same volume and is formed by four radiating elements 91, 92 and 93, 94. Radiating elements 91 and 94 are X-pole radiating elements; radiating elements 92 and 93 are radiating elements with both vertical and horizontal polarizations.

The base cell has two Rx radiating elements 91 and 92, each of which has two orthogonal polarizations, wherein the polarizations of the two radiating elements 91 and 92 are rotated by 45° to each other. Identical radiating elements can also be used, and they are arranged such that they are rotated by 45° to each other on the base plate of the antenna.

The base cell additionally has two Tx transmission elements 93 and 94, each of which has two orthogonal polarizations, wherein the polarizations of the two radiating elements 93 and 94 are rotated by 45° to each other. Identical radiating elements can also be used, and they are arranged such that they are rotated by 45° to each other on the base plate of the antenna.

The design of the third embodiment thus corresponds to that of the first embodiment, the difference being that the radiating elements have two polarizations instead of one and are rotated by 45° to each other rather than 90°.

In a fourth embodiment, which is not shown, a base cell could also consist of four dual-polarized Rx radiating elements or four dual-polarized Tx radiating elements, wherein they are preferably identical radiating elements that are rotated by 45° relative to each other. The fourth embodiment thus corresponds to the second embodiment, the difference being that the radiating elements have two polarizations instead of one and are rotated by 45° to each other rather than 90°.

According to the third and fourth embodiments, an antenna can consist of a plurality of base cells, which are preferably arranged vertically and/or horizontally above or next to each other.

FIG. 16 shows two variants of a fifth embodiment of an antenna, in which dual-polarized Tx radiating elements 121 and dual-polarized Rx radiating elements 122 are employed. The radiating elements 121 and 122 thus have two connectors each, which correspond to different polarizations that are orthogonal to each other. Unlike in the third and fourth embodiments, however, the polarizations of the radiating elements 121 and 122, of which the antenna consists, are oriented identically. Here the radiating elements 121 and 122 in the embodiment are X-pole radiating elements, but radiating elements with a vertical and a horizontal polarization could also be used. All Tx radiating elements 121 can be configured identically and/or can be oriented identically. Furthermore, all Rx radiating elements 122 can be configured identically and/or can be oriented identically. However, the Tx radiating elements 121 preferably have resonance frequency ranges different from those of the Rx radiating elements 122. In particular, the dielectric resonators can have different dimensions.

The antenna 120 shown on the left in FIG. 16 comprises Tx radiating elements 121 and Rx radiating elements 122, which are arranged alternatingly, vertically one above the other, wherein only one column is provided in the embodiment. In this antenna, the base cell 140 consists of only two radiating elements, namely a Tx radiating element 121 and an Rx radiating element 122. In this configuration, multiple base cells of this type are arranged one above the other.

The antenna 130 shown on the right in FIG. 16 comprises Tx radiating elements 121 and Rx radiating elements 122, which are arranged alternatingly, horizontally next to each other, wherein two columns are provided in the embodiment. In this antenna, the base cell 150 consists of four radiating elements, namely two Tx radiating elements 121 and two Rx radiating elements 122. The Rx radiating elements 122 and the Tx radiating elements 121 are arranged opposite each other on the diagonals of the base cells. In this configuration, multiple base cells 150 are arranged one above the other.

Base cell 150 is thus constructed substantially of two base cells 140, although the arrangement of the radiating elements in the two combined base cells 140 is mirrored. Alternatively, the antenna 130 shown in FIG. 16 could also be considered to consist of base cells 140 with only two radiating elements, wherein the base cells in adjacent columns are offset from each other by an individual radiating element interval in the vertical direction.

The individual radiating element intervals between the radiating elements in the base cell, e.g. the group intervals between similar radiating elements of adjacent base cells, can have the values indicated above with respect to the first and the second embodiment. In the embodiment, the individual radiating element interval is 0.25λ and the group interval is 0.5λ relative to the wavelength of the center frequency of the lowest resonance frequency range of the radiating elements involved.

Especially for 3D beam-forming applications, individual radiating element intervals of less than or equal to 0.25λ or group intervals of less than or equal to 0.5λ can be advantageous, for instance, for calculating the angle of incidence (i.e. the position) of the mobile terminal (“user equipment,” abbreviated UE) during channel estimation and to orient the antenna diagram of the base station thereto.

In the third, fourth and fifth aspects, as well, the radiating elements can both be powered individually via the power supply network and be interconnected in any desired way. In particular, a group arrangement, in which similar or identical radiating elements of adjacent base cells are interconnected, makes it possible to perform vertical and/or horizontal beam-forming and/or beam-steering. If, on the other hand, the radiating elements are operated individually, the capacity of the antenna is increased. In particular, the individual connectors of the radiating elements can be fed individually in this instance and can also be interconnected as desired.

Operating modes A and B, which are described with the aid of FIG. 6, can be used in an identical way, including e.g. in the embodiment shown in FIG. 16. Of course, significantly more complex interleaving of the individual elements are also possible.

Furthermore, the antennas shown in FIG. 16 can also be supplemented with further base cells, especially when using an antenna with multiple base cells that are arranged both in horizontal and in vertical rows. There can thus be a multitude of different operating modes, in which the radiating elements are interconnected and operated in different constellations.

The configuration of the radiating elements, the system and group intervals and the antennas consisting of multiple base cells according to the third, fourth and fifth embodiments preferably confirms with the statements made earlier with regard to the first and second embodiments.

An overview of important aspects of the present invention is presented once more below:

The present invention provides a compact multi-port base cell, especially for multi-column antennas, wherein an individual radiating element interval of 0.2λ to 0.6λ between the individual radiating elements in the horizontal and vertical direction is made possible by the use of dielectric material. In so doing, the conventional complexity and losses on the transmitter stage and receiving boosters are prevented when they are interconnected. By using a plurality of base cells that either are operated separately or are interconnected, it is equally possible to carry out both horizontal and vertical beam-forming and/or beam-steering in order, for example, to perform 3D beam-forming and/or beam-steering and achieve higher data rates with 4G or future 5G transmission techniques.

A base cell is used with at least four separate individual radiating elements, which are preferably arranged in front of a common reflector. Separate radiating elements are utilized here for different polarizations of the same frequency band. Moreover, separate radiating elements are used for transmitting and receiving. In particular, there are at least two transmission paths in the same band and/or two receiving paths in the same band, or else there are four transmission paths in the same band or four receiving paths in the same band. The radiating elements for transmitting and the radiating elements for receiving are optimized for the respective frequency ranges, i.e. the transmission radiating elements and the receiving radiating elements have different resonance frequencies. The individual radiating elements are physically distanced from each other by the individual radiating element interval according to the invention, and in particular are spaced apart vertically and horizontally.

The new base cell thus permits a decoupling of more than 10 dB both when the radiating elements are single-fed and when they are group fed. Preferably, decoupling of better than 15 dB can be achieved.

The small individual radiating element interval of 0.2 to 0.6λ in the vertical and horizontal direction results in an increase in the MIMO yield, especially the beam-forming yield, e.g. in 4G and 5G transmission methods.

By using separate narrow-band radiating elements for Rx and Tx, the intermodulation is reduced and additional damping in the duplex filters for Rx and Tx, which are now no longer needed, is avoided. Furthermore, it is possible to rely upon simple band-pass filters with low selection instead of highly selective filters.

When the individual radiating elements have a narrow-band configuration or a configuration designed for narrow-band ranges, they can be installed at a very low height for conventional mobile telecommunication bands.

The physically separated arrangement of the radiating elements with different polarizations improves decoupling between adjacent radiating elements. The same applies to the use of separate radiating elements for the transmission and receiving bands. By using dielectric radiating elements, a small individual radiating element interval of 0.2 to 0.6λ in the horizontal and vertical direction is achieved, which provides appropriate system intervals both for single-feeding and for group feeding.

The antenna is formed from repeating clusters of multiple dielectric individual radiating elements, in particular of multiple similar and preferably identical base cells that repeat in the vertical and/or horizontal direction. The interval between similar or identical radiating elements of adjacent base cells is preferably between 0.4λ and 1.2λ.

The transmission power of the boosters used can thus be less than 2 watts.

1. An antenna for a mobile telecommunication base station, having a plurality of radiating elements and having at least two transmission or having at least two receiving paths, which are linked with two radiating elements of the antenna that are physically spaced apart and have different polarizations, wherein the radiating elements are dielectric radiating elements and wherein an individual radiating element interval between the radiating elements is less than 0.6λ, wherein λ stands for a wavelength of a center frequency of a lowest resonance frequency range of the radiating elements.

2. An antenna for a mobile telecommunication base station, having at least two radiating elements that are physically spaced apart and have different polarizations and/or are operated at different frequencies, wherein the radiating elements are dielectric radiating elements having at least two separate connectors for at least two different polarizations, wherein an individual radiating element interval between the radiating elements is less than 0.6λ, wherein λ stands for a wavelength of a center frequency of a lowest resonance frequency range of the radiating elements.

3. The antenna according to claim 1, wherein the individual radiating element interval between the radiating elements is greater than 0.2λ, wherein λ stands for the wavelength of the center frequency of the lowest resonance frequency range of the radiating elements, wherein the individual radiating element interval between the radiating elements for the center frequencies of all utilized resonance frequency ranges of the radiating elements lies between 0.2λ and 0.6λ, and/or wherein the individual radiating element interval between the radiating elements for the center frequency of the lowest resonance frequency range of the radiating elements is less than or equal to 0.30λ, and/or wherein the individual radiating element interval between the radiating elements for the center frequency of the lowest resonance frequency range of the radiating elements lies between 0.2λ and 0.3λ, and wherein the individual radiating element interval between the radiating elements for the center frequency of a highest utilized resonance frequency range of the radiating elements lies between 0.4λ and 0.6λ.

4. An antenna for a mobile telecommunication base station, wherein the antenna has at least two repeating base cells comprising a plurality of radiating elements, wherein each base cell contains a plurality of radiating elements and at least two transmission or receiving paths, wherein the at least two transmission or receiving paths of each base cell are linked with two radiating elements, which are physically spaced apart and have different polarizations, wherein the radiating elements are dielectric radiating elements,
and/or
wherein the antenna has at least two repeating base cells comprising a plurality of radiating elements, wherein each base cell comprises at least two radiating elements, which are physically distanced from each other and have different polarizations and/or are operated at different frequencies, and wherein the radiating elements are dielectric radiating elements having at least two separate connectors for at least two different polarizations.

5. The antenna according to claim 4, wherein the base cells repeat at a group interval of between 0.4λ and 1.2λ, wherein λ stands for a wavelength of the center frequency of a lowest resonance frequency range of the radiating elements wherein the group interval for the center frequencies of all utilized resonance frequency ranges of the radiating elements lies between 0.4λ and 1.2λ, and/or wherein the group interval for the center frequency of the lowest resonance frequency range of the radiating element is less than or equal to 0.6λ, and/or wherein the group interval for the center frequency of the lowest resonance frequency range of the radiating elements lies between 0.4λ and 0.6λ and for the center frequency of a highest utilized resonance frequency range of the radiating elements between 0.8λ and 1.2λ, and/or wherein similar or identical radiating elements of adjacent base cells have twice the individual radiating element interval of the radiating elements within a base cell.

6. The antenna according to claim 1, wherein a separation is established between the transmission paths and the receiving paths, wherein the antenna has at least two receiving paths and at least two transmission paths, each of which is linked with two physically distant radiating elements having different polarizations, and/or wherein the antenna has at least two transmission and at least two receiving paths, which are linked with two physically distant radiating elements that have at least two connectors each, wherein the two transmission paths are linked with two connectors of a first radiating element and the two receiving paths are linked with two connectors of a second radiating element.

7. The antenna according to claim 6, wherein the two radiating elements that are linked with the transmission paths have polarizations that are orthogonal or rotated 45° to each other, and/or
wherein the two radiating elements that are linked with the receiving paths have polarizations that are orthogonal or rotated 45° to each other.

8. The antenna according to claim 1, wherein the at least two transmission paths serve to transmit signals in a same frequency range and/or mobile telecommunication band and/or are linked with two radiating elements having the same resonance frequency range, wherein the at least two transmission paths are linked with two identical radiating elements, which are arranged such that they are rotated relative to each other at a prescribed angle, and/or
wherein the at least two receiving paths serve to receive signals in the same frequency range and/or mobile telecommunication band and/or are linked with two radiating elements having the same resonance frequency range, wherein the at least two receiving paths are linked with two identical radiating elements, which are arranged such that they are rotated relative to each other at a prescribed angle,
and/or having at least two transmission paths that are linked with two connectors of a radiating element, wherein the two transmission paths serve to transmit signals in the same resonance frequency range and/or mobile telecommunication band, and/or wherein the two connectors of the radiating element have the same resonance frequency range and different polarizations, and/or having at least two receiving paths that are linked with two connectors of a radiating element, wherein the two receiving paths serve to receive signals in the same resonance frequency range and/or mobile telecommunication band, and/or wherein the two connectors of the radiating element have the same resonance frequency range and different polarizations,
and/or
wherein radiating elements that are linked to the transmission paths and the radiating elements that are linked to the receiving paths are constructed different and/or have different resonance frequency ranges, wherein the resonance frequency ranges correspond to a transmission range and a receiving range, respectively, of a mobile telecommunication range, wherein the resonance frequency ranges of the radiating elements do not cover both a transmission range and a receiving range of a mobile telecommunication range,
and/or wherein the radiating elements that are operated at different frequencies are constructed differently and/or have different resonance frequency ranges, wherein said resonance frequency ranges correspond to a transmission range and a receiving range, respectively, of a mobile telecommunication band, wherein the resonance frequency ranges of the radiating elements do not cover both a transmission range and a receiving range of a mobile telecommunication band.

9. The antenna according to claim 1, wherein the antenna has at least two receiving paths and at least two transmission paths, each of which is linked separately to one of four physically distant radiating elements, wherein the two radiating elements of the receiving path have polarizations that are rotated 45° or 90° relative to each other, and the two radiating elements of the transmission paths have polarizations that are rotated 45° or 90° relative to each other,
and/or
wherein the antenna has at least four receiving paths or at least four transmission paths, each of which is linked separately to one of four physically distant radiating elements, wherein the four radiating elements have polarizations that are rotated by 90° relative to each other,
and/or
wherein the antenna has at least two receiving paths and at least two transmission paths, each of which is linked separately to the connectors of two physically distant radiating elements, wherein the two radiating elements have polarizations that are identical or that are rotated 45° or 90° relative to each other,
and/or
wherein the antenna has at least four physically distant radiating elements, which form a 2-dimensional antenna arrangement, wherein the radiating elements are arranged with predetermined vertical and horizontal spacing from each other, in horizontal rows and/or vertical columns each having at least two radiating elements.

10. The antenna according to claim 1, wherein at least one of the radiating elements are configured for narrow-band signals, wherein a or each resonance frequency range covers only one transmission or one receiving range of a mobile telecommunication band, and/or wherein at least one of the radiating elements has multiple separate resonance frequency ranges and/or covers the transmission or the receiving range of different mobile telecommunication bands over different resonance frequency ranges, wherein the radiating element(s) have 2 or 3 or more separate resonance frequency ranges and/or cover the transmission or receiving ranges of 2 or 3 or more different mobile telecommunication bands separately from each other.

11. The antenna according to claim 1, wherein said antenna is an active antenna, wherein boosters are arranged in the receiving and/or transmission paths, wherein each receiving and/or transmission path has at least one separate booster, and/or wherein the transmission power of each booster is less than 2 watts, and/or wherein all receiving and/or transmission paths can be controlled separately.

12. The antenna according to claim 1, wherein the antennas are arranged on a common printed circuit board, wherein the boosters and/or filters are arranged together with the radiating elements on the common printed circuit board, and/or wherein the antenna has a common reflector for all radiating elements, and/or wherein dielectric bodies with or without electro-plating are used as radiating elements, and/or wherein the dielectric bodies are arranged on a support, and/or wherein a dielectric support and/or other techniques for reducing the relative permittivity and/or increasing the bandwidth and/or increasing the quality or edge steepness of the dielectric bodies are provided, and/or wherein the dielectric radiating elements have a parallelepiped dielectric body and/or are powered via a stripline and/or via a slot arranged under the dielectric body.

13. The antenna according to claim 1, wherein the resonance frequency range(s) of the radiating elements lie between 1 GHz and 35 GHz, and/or wherein the resonance frequency range(s) have a maximum width of less than 20% of the respective center frequency of the resonance frequency range,
and/or wherein further radiating elements are arranged between the radiating elements,
wherein the further radiating elements have one or more higher resonance frequency ranges, wherein a center frequency of a lowest resonance frequency range of the further radiating elements is larger than a center frequency of a highest used resonance frequency range of the radiating elements,
and/or wherein the further radiating elements are dielectric resonators that have a volume of less than 40% of the volume of the largest radiating elements,
and/or wherein the further radiating elements are configured as printed circuit board radiating elements that are integrated into the printed circuit board that feeds the radiating elements.

14-15. (canceled)

16. The antenna according to claim 2, wherein the individual radiating element interval between the radiating elements is greater than 0.2λ, wherein λ stands for the wavelength of the center frequency of the lowest resonance frequency range of the radiating elements, wherein the individual radiating element interval between the radiating elements for the center frequencies of all utilized resonance frequency ranges of the radiating elements lies between 0.2λ and 0.6λ, and/or wherein the individual radiating element interval between the radiating elements for the center frequency of the lowest resonance frequency range of the radiating elements is less than or equal to 0.30λ, and/or wherein the individual radiating element interval between the radiating elements for the center frequency of the lowest resonance frequency range of the radiating elements lies between 0.2λ and 0.3λ, and wherein the individual radiating element interval between the radiating elements for the center frequency of a highest utilized resonance frequency range of the radiating elements lies between 0.4λ and 0.6λ.

17. The antenna according to claim 2, wherein a separation is established between the transmission paths and the receiving paths, wherein the antenna has at least two receiving paths and at least two transmission paths, each of which is linked with two physically distant radiating elements having different polarizations, and/or wherein the antenna has at least four transmission or receiving paths, which are linked with four physically distant radiating elements that have different polarizations, and/or wherein the antenna has at least two transmission and at least two receiving paths, which are linked with two physically distant radiating elements that have at least two connectors each, wherein the two transmission paths are linked with two connectors of a first radiating element and the two receiving paths are linked with two connectors of a second radiating element.

18. The antenna according to claim 4, wherein a separation is established between the transmission paths and the receiving paths, wherein the antenna and/or the base cell has at least two receiving paths and at least two transmission paths, each of which is linked with two physically distant radiating elements having different polarizations, and/or wherein the antenna and/or base cell has at least four transmission or receiving paths, which are linked with four physically distant radiating elements that have different polarizations, and/or wherein the antenna and/or base cell has at least two transmission and at least two receiving paths, which are linked with two physically distant radiating elements that have at least two connectors each, wherein the two transmission paths are linked with two connectors of a first radiating element and the two receiving paths are linked with two connectors of a second radiating element.

19. The antenna according to claim 2, wherein the two radiating elements that are linked with the transmission paths have polarizations that are orthogonal or rotated 45° to each other, and/or
wherein the two radiating elements that are linked with the receiving paths have polarizations that are orthogonal or rotated 45° to each other, and/or
wherein the four radiating elements, with which the at least four transmission paths are linked, each have polarizations that are rotated 90° or 45° relative to each other, and/or
wherein the four radiating elements, with which the at least four receiving paths are linked, each have polarizations that are rotated 90° or 45° relative to each other.

20. The antenna according to claim 18, wherein the two radiating elements that are linked with the transmission paths have polarizations that are orthogonal or rotated 45° to each other, and/or
wherein the two radiating elements that are linked with the receiving paths have polarizations that are orthogonal or rotated 45° to each other, and/or
wherein the four radiating elements, with which the at least four transmission paths are linked, each have polarizations that are rotated 90° or 45° relative to each other, and/or
wherein the four radiating elements, with which the at least four receiving paths are linked, each have polarizations that are rotated 90° or 45° relative to each other.

21. The antenna according to claim 2, wherein said antenna is an active antenna, wherein boosters are arranged in the receiving and/or transmission paths, wherein each receiving and/or transmission path has at least one separate booster, and/or wherein the transmission power of each booster is less than 2 watts, and/or wherein all receiving and/or transmission paths can be controlled separately.

22. The antenna according to claim 4, wherein said antenna is an active antenna, wherein boosters are arranged in the receiving and/or transmission paths, wherein each receiving and/or transmission path has at least one separate booster, and/or wherein the transmission power of each booster is less than 2 watts, and/or wherein all receiving and/or transmission paths can be controlled separately.
